(19) United States
(12) Patent Application Publication
(10) Pub. No.: US 2013/0231946 A1
(43) Pub. Date: Sep. 5, 2013

(54) DIAGNOSTIC READING REPORT GENERATION SUPPORTING SYSTEM, DIAGNOSTIC READING REPORT GENERATION SUPPORTING APPARATUS, AND DIAGNOSTIC READING REQUESTING APPARATUS

(71) Applicants: KABUSHIKI KAISHA TOHIBA, Tokyo (JP); TOSHIBA MEDICAL SYSTEMS CORPORATION, Otawara-Shi (JP)

(72) Inventors: Masato SHIBUYA, Otawara-Shi (JP); Iwao Goto, Nasushiobara-Shi (JP); Tomoko Kazuno, Nasushiobara-Shi (JP)

(73) Assignees: Toshiba Medical Systems Corporation, Otawara-Shi (JP); Kabushiki Kaisha Tohiba, Tokyo (JP)

(21) Appl. No.: 13/782,228

(22) Filed: Mar. 1, 2013

(30) Foreign Application Priority Data
Mar. 2, 2012 (JP) 2012-047089

(51) Int. Cl. G06F 19/00

(52) U.S. Cl. CPC G06F 19/321
USPC 705/2

(57) ABSTRACT

A diagnostic reading report generation supporting system includes a first storage, a second storage, a first extraction unit a second extraction unit and a transmission unit. The first storage stores a medical image. The second storage stores: user identification information on a diagnostic reading requester, examination information, fixed phrase name information, and fixed phrase character information. The first extraction unit extracts a medical image, from the first storage. The second extraction unit extracts a fixed phrase name information item corresponding to a required user identification information item and examination information item, from the second storage. The transmission unit transmits diagnostic reading request information including: the extracted medical image; the extracted fixed phrase name information item; and a user identification information item, an examination information item and a fixed phrase character information item associated with the extracted fixed phrase name information item, to an external apparatus.

### CROSS-REFERENCE TO RELATED APPLICATION

This application is based upon and claims the benefit of priority from Japanese Patent Application No. 2012-47089, filed on Mar. 2, 2012, the entire contents of which are incorporated herein by reference.

### FIELD

The present embodiment as an aspect of the present invention relates to a diagnostic reading report generation supporting system, a diagnostic reading report generation supporting apparatus, and a diagnostic reading requesting apparatus that support generation of a diagnostic reading report.

### BACKGROUND

Some diagnostic reading report generation supporting systems are made up of a medical imaging apparatus, a medical image server apparatus, a diagnostic reading report server apparatus, a viewer apparatus, and a diagnostic reading report generation supporting apparatus. In such a diagnostic reading report generation supporting system, a diagnostic reader (person) can attach, to his/her medical comment, a fixed phrase associated with examination information and imaging region information through a particular operation, in order to generate a diagnostic reading report.

Some diagnostic reading report generation supporting system are located in the respective hospitals and configured to be connected with each other via a network. In the diagnostic reading report generation supporting system, a report generator (person) of a diagnostic reading report comes and goes among the plurality of hospitals, and generates a diagnostic reading report in each hospital. The diagnostic reading report generation supporting system may have a remote diagnostic reading function of requesting, from a given hospital, a diagnostic reading specialized institution to make a diagnostic reading and acquiring diagnostic reading results from a diagnostic reading center.

According to a conventional technique, fixed phrase character information of fixed phrases that are candidates of a medical comment to be inputted to a medical comment section is displayed on a diagnostic reading report generation screen displayed at the time of generation of a diagnostic reading report. In the case where a large number of fixed phrases exist as in an endoscopic examination and the like, however, it is necessary to display fixed phrase character information of the large number of fixed phrases as candidates of a medical comment. In that case, an operation such as a scrolling operation for display switching by a report generator is essential, and hence the diagnostic reading efficiency of the report generator at the time of generation of a diagnostic reading report is low.

Further, the contents of fixed phrases are different for each report generator, each hospital, and each examination. For fixed phrases used at the time of generation of a diagnostic reading report, the contents of fixed phrases displayed on the basis of examination information can be changed, but display format information of the fixed phrases cannot be changed. Accordingly, fixed phrases best suited to generate a diagnostic reading report are not necessarily displayed on a screen, and hence the diagnostic reading efficiency of the report generator is low.

Furthermore, a given report generator may come and go between different hospitals (a first hospital and a second hospital) to make a diagnostic reading. Even if fixed phrase character information is registered in the first hospital, in the case where the fixed phrase character information registered in the first hospital is used in the second hospital, the fixed phrase character information needs to be registered again in the second hospital. Otherwise, the fixed phrase character information is exported from (written out of) the first hospital in which the information has already been registered, in the form of a file, and the exported result is transmitted to the second hospital to be imported to (read in) the second hospital. In this manner, the fixed phrase character information needs to be transferred for use. In those cases, the re-registration work, the write-out work, and the read-in work require time and effort, and hence the diagnostic reading efficiency of the report generator is low.

In addition, generation of a diagnostic reading report may be requested from a hospital to a specialized institution such as a diagnostic reading center. The hospital as the request source does not have the way of transmitting fixed phrase character information desired to be used, to the specialized institution as the request destination, and it is difficult for the specialized institution as the diagnostic reading request destination to generate a diagnostic reading report including the fixed phrase character information desired by the hospital as the diagnostic reading request source.

### BRIEF DESCRIPTION OF THE DRAWINGS

In accompanying drawings,

FIG. 1 is a schematic diagram illustrating a configuration of a diagnostic reading report generation supporting system according to a first embodiment;

FIG. 2 is a diagram illustrating a configuration of the diagnostic reading report generation supporting apparatus;

FIG. 3 is a diagram illustrating an example of a first table managed by a database;

FIG. 4 is a diagram illustrating an example of a second table managed by a database;

FIG. 5 is a diagram illustrating an example of a third table managed by a database;

FIG. 6 is a diagram illustrating an example of a fourth table managed by a database;

FIG. 7 is a diagram illustrating a fifth table as a modified example of the first to fourth tables;

FIG. 8 is a diagram illustrating a sixth table as a modified example of the first and second tables;

FIG. 9 is a flow chart illustrating an operation of the diagnostic reading report generation supporting system according to the first embodiment;

FIG. 10 is a diagram illustrating an example of a diagnostic reading report generation screen;

FIGS. 11A and 11B are diagrams each illustrating a method of selecting a fixed phrase name information item from a list of a fixed phrase name information items;

FIG. 12 is a schematic diagram illustrating a configuration of a diagnostic reading report generation supporting system according to a second embodiment;

FIG. 13 is a diagram illustrating an example of a first table managed by a database;

FIG. 14 is a diagram illustrating an example of a second table managed by a database;

FIG. 15 is a diagram illustrating an example of a third table managed by a database;

FIG. 16 is a diagram illustrating an example of a fourth table managed by a database;

FIG. 17 is a flow chart illustrating an operation of the diagnostic reading report generation supporting system according to the second embodiment;

FIG. 18 is a flow chart illustrating an operation of the diagnostic reading report generation supporting system according to the second embodiment;

FIG. 19 is a flow chart illustrating an operation of the diagnostic reading report generation supporting system according to the second embodiment;

FIG. 20 is a diagram illustrating an example of a transmission screen;

FIG. 21 is a schematic diagram illustrating a configuration of a diagnostic reading report generation supporting system according to a third embodiment;

FIG. 22 is a flow chart illustrating an operation of the diagnostic reading report generation supporting system according to the third embodiment;

FIG. 23 is a flow chart illustrating an operation of the diagnostic reading report generation supporting system according to the third embodiment; and

FIG. 24 is a diagram illustrating an example of a diagnostic reading request screen.

### DETAILED DESCRIPTION

A diagnostic reading report generation supporting system, a diagnostic reading report generation supporting apparatus, and a diagnostic reading requesting apparatus according to the present embodiment are described with reference to the attached drawings.

To solve the above-described problems, the diagnostic reading report generation supporting system according to the present embodiment includes: a first storage configured to store a medical image; a second storage configured to store: user identification information on a diagnostic reading requester; examination information on an examination for collecting the medical image; fixed phrase name information that is character information for identifying a fixed phrase; and fixed phrase character information that is character information of the fixed phrase; a first extraction unit configured to extract a medical image as a diagnostic reading target, from the first storage; a second extraction unit configured to extract a fixed phrase name information item corresponding to a required user identification information item and examination information item, from the second storage; and a transmission unit configured to transmit diagnostic reading request information including: the extracted medical image; the extracted fixed phrase name information item; and a user identification information item, an examination information item and a fixed phrase character information item associated with the extracted fixed phrase name information item, to an external apparatus via a network.

To solve the above-described problems, the diagnostic reading report generation supporting apparatus according to the present embodiment includes: a first storage configured to store a medical image; a second storage configured to store: user identification information on a diagnostic reading requester; examination information on an examination for collecting the medical image; fixed phrase name information that is character information for identifying a fixed phrase; and fixed phrase character information that is character information of the fixed phrase; a first extraction unit configured to extract a medical image as a diagnostic reading target, from the first storage; a second extraction unit configured to extract a fixed phrase name information item corresponding to a required user identification information item and examination information item, from the second storage; and a transmission unit configured to transmit diagnostic reading request information including: the extracted medical image; the extracted fixed phrase name information item; and a user identification information item, an examination information item and a fixed phrase character information item associated with the extracted fixed phrase name information item, to an external apparatus via a network.

To solve the above-described problems, the diagnostic reading report generation supporting system according to the present embodiment includes: a storage configured to store: user identification information on a diagnostic reading requester; examination information on an examination for collecting the medical image; fixed phrase name information that is character information for identifying a fixed phrase; and fixed phrase character information that is character information of the fixed phrase; an extraction unit configured to extract a fixed phrase name information item corresponding to a required user identification information item and examination information item, from the storage; and a transmission unit configured to transmit diagnostic reading request information including: the extracted fixed phrase name information item; and a user identification information item, an examination information item and a fixed phrase character information item associated with the extracted fixed phrase name information item, to an external apparatus via a network.

To solve the above-described problems, the diagnostic reading requesting apparatus according to the present embodiment includes: an extraction unit configured to extract a fixed phrase name information item corresponding to a required user identification information item and examination information item, from an extraction unit configured to extract a fixed phrase name information item corresponding to a required user identification information item and examination information item, from a storage which store: user identification information on a diagnostic reading requester; examination information on an examination for collecting the medical image; fixed phrase name information that is character information for identifying a fixed phrase; and fixed phrase character information that is character information of the fixed phrase; and a transmission unit configured to transmit diagnostic reading request information including: the extracted fixed phrase name information item; and a user identification information item, an examination information item and a fixed phrase character information item associated with the extracted fixed phrase name information item, to an external apparatus via a network.

### First Embodiment

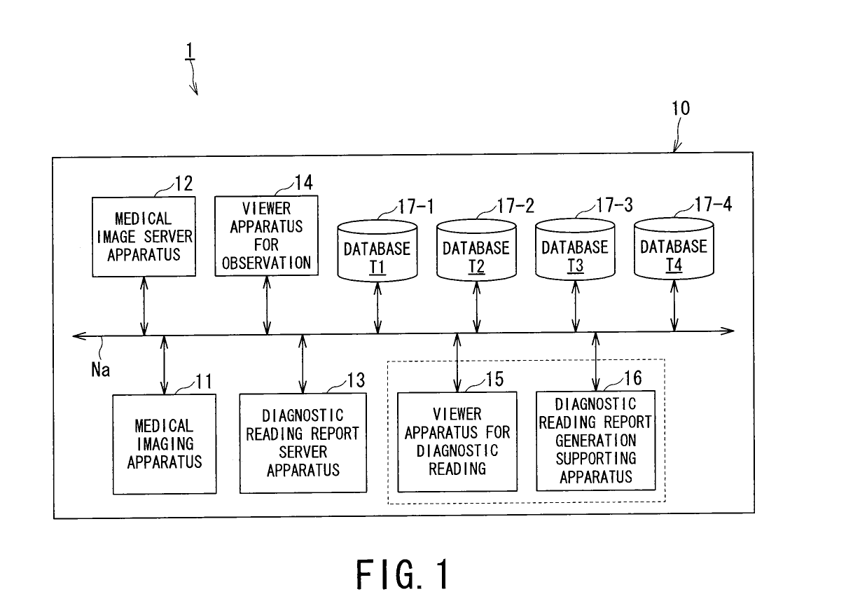

FIG. 1 is a schematic diagram illustrating a configuration of a diagnostic reading report generation supporting system according to a first embodiment.

FIG. 1 illustrates a diagnostic reading report generation supporting system 1 according to the first embodiment. The diagnostic reading report generation supporting system 1 is installed in a medical institution (hospital) 10. The hospital 10 includes a medical imaging apparatus (modality) 11, a medical image server apparatus 12, a diagnostic reading report server apparatus 13, a viewer apparatus for observation 14, a viewer apparatus for diagnostic reading 15, a diagnostic reading report generation supporting apparatus 16, and a database group 17 (17-1 to 17-4). These apparatuses are mutually communicable via a network Na such as a backbone local area network (LAN). Note that the number(s) of the entirety or a part of the apparatuses 11 to 16 installed in the hospital 10 may be more than one.

The medical imaging apparatus 11 photographs an image of examination imaging region information of a patient as an object, and generates a medical image of the examination imaging region information as medical data. The generated medical image is transmitted as DICOM data to the medical image server apparatus 12. Examples of the medical imaging apparatus 11 includes an endoscopic examination apparatus, an X-ray diagnosis apparatus, an X-ray computed tomography (CT) apparatus, a magnetic resonance imaging (MRI) apparatus, an ultrasonic diagnosis apparatus, and a nuclear medicine diagnosis apparatus.

The medical image server apparatus 12 stores the image data collected by the medical imaging apparatus 11. The medical image server apparatus 12 provides the image data to the viewer apparatuses 14 and 15 in response to requests from the viewer apparatuses 14 and 15. Note that the medical image server apparatus 12 has functions concerning the medical image such as differencing with time, integration (fusion), multi-planar reconstruction (MPR), 3D display conversion, and supplementary information management. In the case of storing the image data, the medical image server apparatus 12 transmits supplementary information attached to the image data to the diagnostic reading report server apparatus 13. The supplementary information contains an acceptance number, patient information, examination information, and the like. Examples of the patient information include a patient identification (ID) and a patient name. Examples of the examination information include examination type information (CT, MR, and the like) and imaging region information of the object.

The diagnostic reading report server apparatus 13 receives the supplementary information from the medical image server apparatus 12, and stores a diagnostic reading report before input (a diagnostic reading report in which a disease case input section, a medical comment input section, and other such sections are blank) including the received supplementary information, in association with its acceptance number. Then, the diagnostic reading report server apparatus 13 provides the diagnostic reading report before input to the diagnostic reading report generation supporting apparatus 16 in response to a request from the diagnostic reading report generation supporting apparatus 16. The diagnostic reading report server apparatus 13 stores as appropriate a diagnostic reading report after input generated by a diagnostic reader, and provides the diagnostic reading report to the viewer apparatus for observation 14 in response to a request from the viewer apparatus for observation 14.

The viewer apparatus for observation 14 displays the medical image stored in the medical image server apparatus 12, the diagnostic reading report after input stored in the diagnostic reading report server apparatus 13, and the like. The viewer apparatus for observation 14 is installed in, for example, a consultation room in the hospital, and provides the medical image and the diagnostic reading report to a doctor in charge of the patient. The viewer apparatus for observation 14 enables the doctor in charge to view the medical image and the diagnostic reading report.

The viewer apparatus for diagnostic reading 15 displays the medical image stored in the medical image server apparatus 12, the diagnostic reading report before input stored in the diagnostic reading report server apparatus 13, and the like. The viewer apparatus for diagnostic reading 15 is installed in, for example, a diagnostic reading room in the hospital, and provides the medical image to a report generator such as the diagnostic reader who generates the diagnostic reading report. The viewer apparatus for diagnostic reading 15 enables the report generator to view the medical image as the diagnostic reading target.

The diagnostic reading report generation supporting apparatus 16 supports generation work of the report generator on the diagnostic reading report before input (before registration) stored in the diagnostic reading report server apparatus 13. The diagnostic reading report generation supporting apparatus 16 is installed in, for example, the diagnostic reading room in the hospital next to the viewer apparatus for diagnostic reading 15, and supports generation work when the report generator generates the diagnostic reading report. Note that the report generator generates the diagnostic reading report on the medical image as the diagnostic reading target using the diagnostic reading report generation supporting apparatus 16 while viewing the medical image displayed on the viewer apparatus for diagnostic reading 15.

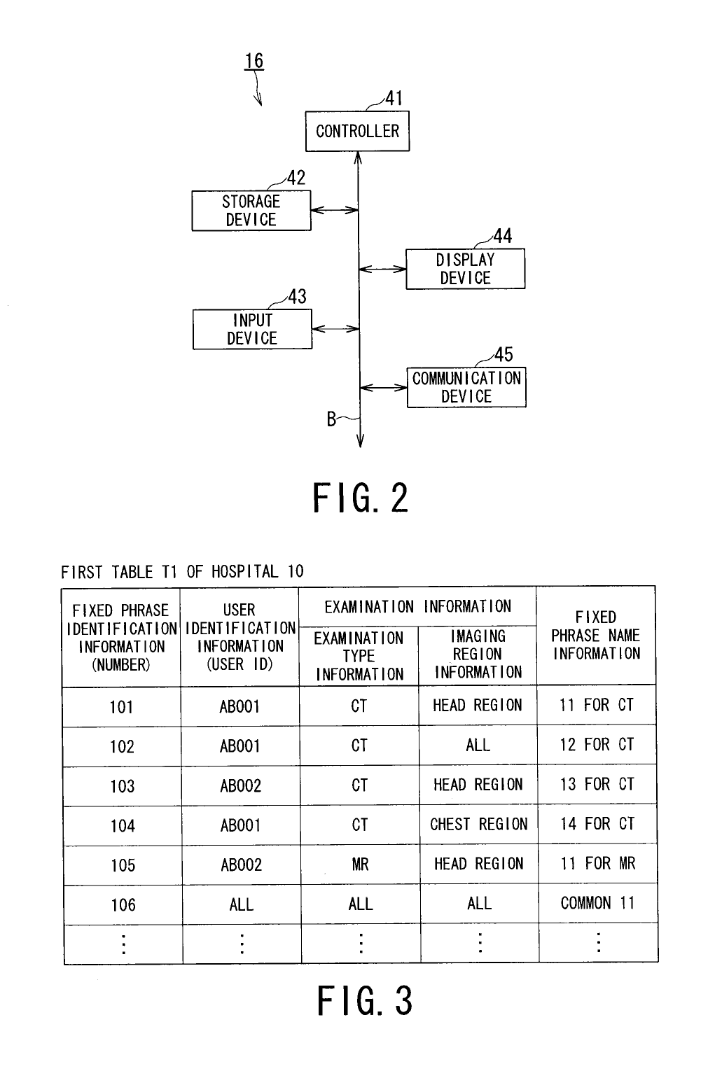

FIG. 2 is a diagram illustrating a configuration of the diagnostic reading report generation supporting apparatus 16.

As illustrated in FIG. 2, the diagnostic reading report generation supporting apparatus 16 includes a controller 41, a storage device 42, an input device 43, a display device 44, and a communication device 45. The units 41 to 45 are electrically connected to one another via a bus B.

The controller 41 is configured by a microprocessor and the like that control the other units. The controller 41 controls the other units on the basis of various programs and data items stored in the storage device 42. Particularly in response to an input operation on the input device 43 by the report generator, the controller 41 controls the other units on the basis of the programs and the data items. Further, on the basis of the various programs, the controller 41 performs: a series of data handling for calculation or processing of the various data items; an image display process for displaying images of diagnostic reading reports; and the like.

The storage device 42 is configured by a read only memory (ROM), a random access memory (RAM), a flash memory, or the like that stores the various programs and data items. The storage device 42 is a memory that stores the various programs such as an activation program executed by the controller 41, and is a memory that also functions as a work area of the controller 41. Note that the activation program is read out and executed by the controller 41 at the time of activation of the diagnostic reading report generation supporting apparatus 16.

The input device 43 is configured by input devices such as a mouse and a keyboard. The input device 43 is an operation unit on which the report generator (user) such as the diagnostic reader performs an input operation. The input device 43 is used, for example, when the report generator generates a diagnostic reading report.

The display device 44 is configured by a liquid crystal display, a cathode ray tube (CRT) display, and the like. The display device 44 is a display apparatus that performs a display operation for displaying a diagnostic reading report for report generation.

The communication device 45 is a communication interface that makes communications with external apparatuses via a network N. Examples of the external apparatuses include the medical image server apparatus 12, the diagnostic reading report server apparatus 13, the viewer apparatus for diagnostic reading 15, and the databases 17-1 to 17-4.

Returning back to the description of FIG. 1, the database 17-1 stores a first table T1. In the first table T1, fixed phrase identification information is associated with the combination of: user identification information; examination information (for example, examination type information indicating the type of the medical imaging apparatus 11 and imaging region information) of an examination for collecting medical images; and fixed phrase name information that is simple character information for identifying a fixed phrase.

FIG. 3 is a diagram illustrating an example of the first table T1 managed by the database 17-1.

As illustrated in FIG. 3, if desired fixed phrase name information is registered to the combination of user identification information and examination information, a fixed phrase identification information item “101” is associated therewith. That is, in the first table T1, the fixed phrase identification information item “101” is associated with the combination of: a user identification information item “AB001”; an examination type information item “CT” and an imaging region information item “head region” as the examination information; and a fixed phrase name information item “11 for CT”. Similarly, in the first table T1, a fixed phrase identification information item “102” is associated with the combination of: the user identification information item “AB001”; the examination type information item “CT” and an imaging region information item “ALL (all imaging regions)” as the examination information; and a fixed phrase name information item “12 for CT”. It is discussed here that the user identification information item “AB001” and the examination type information item “CT” and the imaging region information item “head region” as the examination information are set as the conditions. In that case, the fixed phrase identification information items “101”, “102”, and “106” and the fixed phrase name information items “11 for CT”, “12 for CT”, and “common 11” are extracted on the basis of the first table T1. Note that procedure information, contrast agent information, and the like may be considered as the examination information. Alternatively, fixed phrase identification information may be associated with the combination of user identification information, examination information, fixed phrase name information, and hospital information.

Returning back to the description of FIG. 1, the database 17-2 stores a second table T2. In the second table T2, fixed phrase identification information is associated with the combination of: fixed phrase name display position information indicating a display position of fixed phrase name information; and fixed phrase character information that is character information of a fixed phrase.

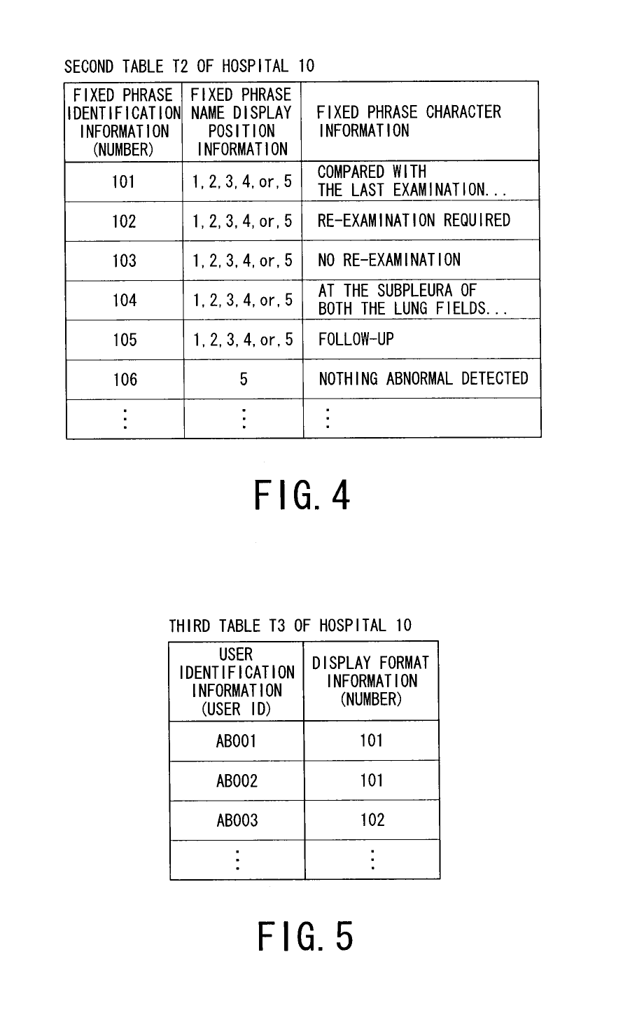

FIG. 4 is a diagram illustrating an example of the second table T2 managed by the database 17-2.

As illustrated in FIG. 4, in the second table T2, the fixed phrase identification information item “101” is associated with the combination of: a fixed phrase name display position information item “1, 2, 3, 4, or 5”; and a fixed phrase character information item “Compared with the last examination . . . ”. That is, the fixed phrase identification information item “101” may be displayed at the position of a fixed phrase name display position information item “1”, and may be displayed at the position of a fixed phrase name display position information item “5”. It is discussed here that the user identification information item “AB001” and the examination type information item “CT” and the imaging region information item “head region” as the examination information are set as the conditions. In that case, the fixed phrase identification information items “101”, “102”, and “106” and the fixed phrase name information items “11 for CT”, “12 for CT”, and “common 11” are extracted on the basis of the first table T1 illustrated in FIG. 3. Further, the fixed phrase name display position information items “1, 2, 3, 4, or 5”, “1, 2, 3, 4, or 5”, and “5” and the fixed phrase character information items “Compared with the last examination . . . ”, “re-examination required”, and “nothing abnormal detected” corresponding to the extracted fixed phrase identification information items “101”, “102”, and “106” are extracted on the basis of the second table T2 illustrated in FIG. 4.

In the second table T2, for example, a medical comment sentence that is directly inputted through an input operation by the report generator is registered as fixed phrase character information, and, after input of a medical comment sentence, the medical comment sentence is copied and registered as fixed phrase character information.

Returning back to the description of FIG. 1, the database 17-3 stores a third table T3. In the third table T3, user identification information is associated with display format information for displaying a fixed phrase.

FIG. 5 is a diagram illustrating an example of the third table T3 managed by the database 17-3.

It is discussed here that the user identification information item “AB001” and the examination type information item “CT” and the imaging region information item “head region” as the examination information are set as the conditions. In that case, a display format information item “101” corresponding to the user identification information item “AB001” is extracted on the basis of the third table T3 illustrated in FIG. 5.

Returning back to the description of FIG. 1, the database 17-4 stores a fourth table T4. In the fourth table T4, display format information is associated with syntactic information (XML format).

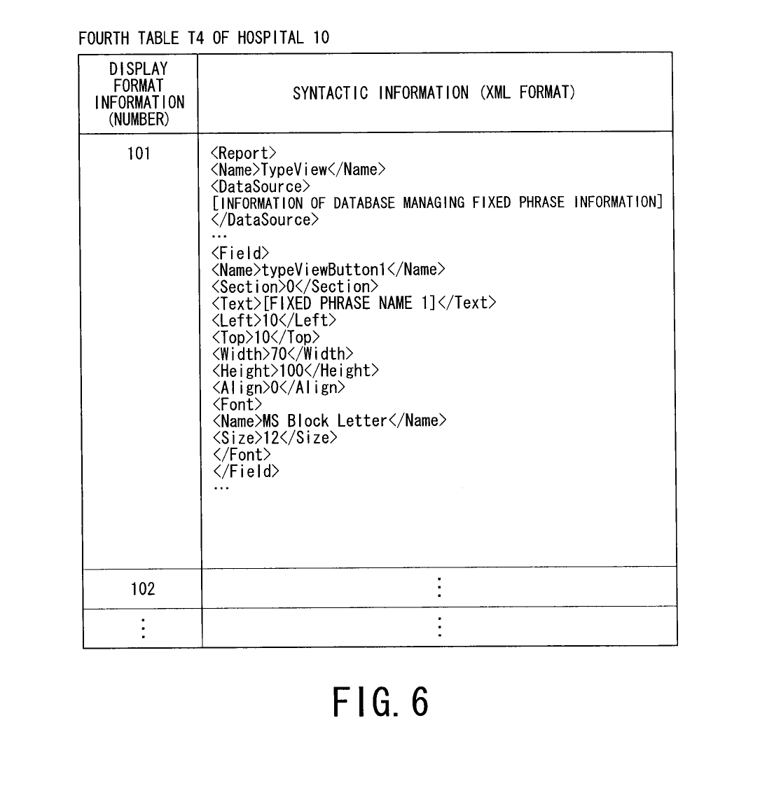

FIG. 6 is a diagram illustrating an example of the fourth table T4 managed by the database 17-4.

It is discussed here that the user identification information item “AB001” and the examination type information item “CT” and the imaging region information item “head region” as the examination information are set as the conditions. In that case, the display format information item “101” corresponding to the user identification information item “AB001” is extracted on the basis of the third table T3 illustrated in FIG. 5. Further, syntactic information corresponding to the extracted display format information item “101” is extracted on the basis of the fourth table T4 illustrated in FIG. 6.

On a setting screen (not illustrated), a given user designates the user identification information item “AB001” with regard to the examination type information item “CT” and the imaging region information item “head region” as the examination information, and designates fixed phrase name display position information, fixed phrase character information, and syntactic information. In that case, fixed phrase identification information and fixed phrase name information (a fixed phrase name that does not coincide with fixed phrase names that have already been registered) are determined and registered to the tables T1 to T4.

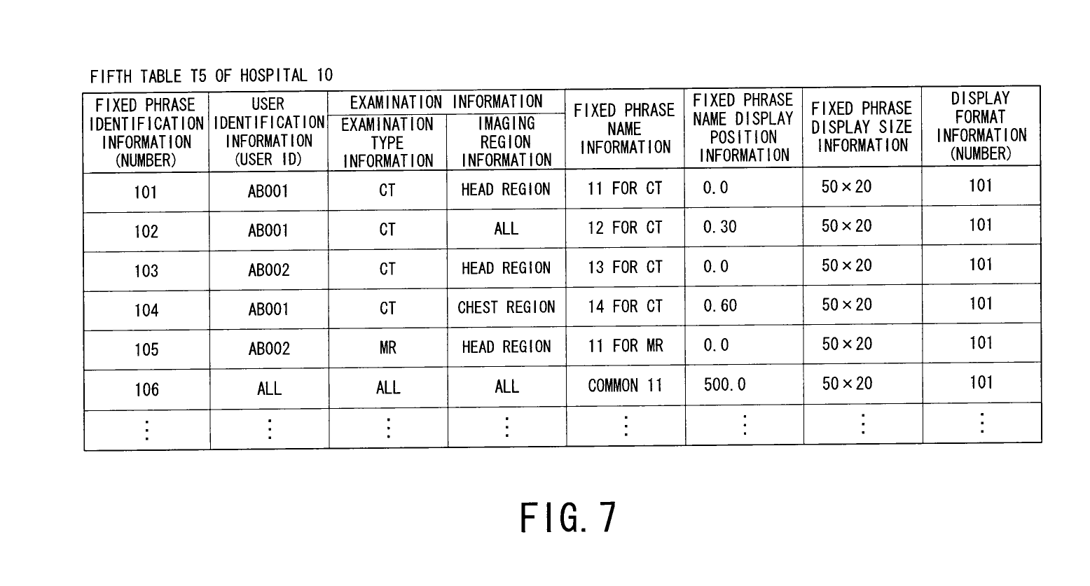

FIG. 7 is a diagram illustrating a fifth table as a modified example of the tables T1 to T4.

As illustrated in FIG. 7, in the fifth table T5, the fixed phrase identification information item “101” is associated with the combination of: the user identification information item “AB001”; the examination type information item “CT” and the imaging region information item “head region” as the examination information; the fixed phrase name information item “11 for CT”; a fixed phrase display position information item “0 in abscissa, 0 in ordinate”; a fixed phrase display size information item “50 in width×20 in height”; and the display format information item “101”. Similarly, in the fifth table T5, the fixed phrase identification information item “102” is associated with the combination of: the user identification information item “AB001”; the examination type information item “CT” and the imaging region information item “ALL (all imaging regions)” as the examination information; the fixed phrase name information item “12 for CT”; a fixed phrase display position information item “0, 30”; the fixed phrase display size information item “50×20”; and the display format information item “101”.

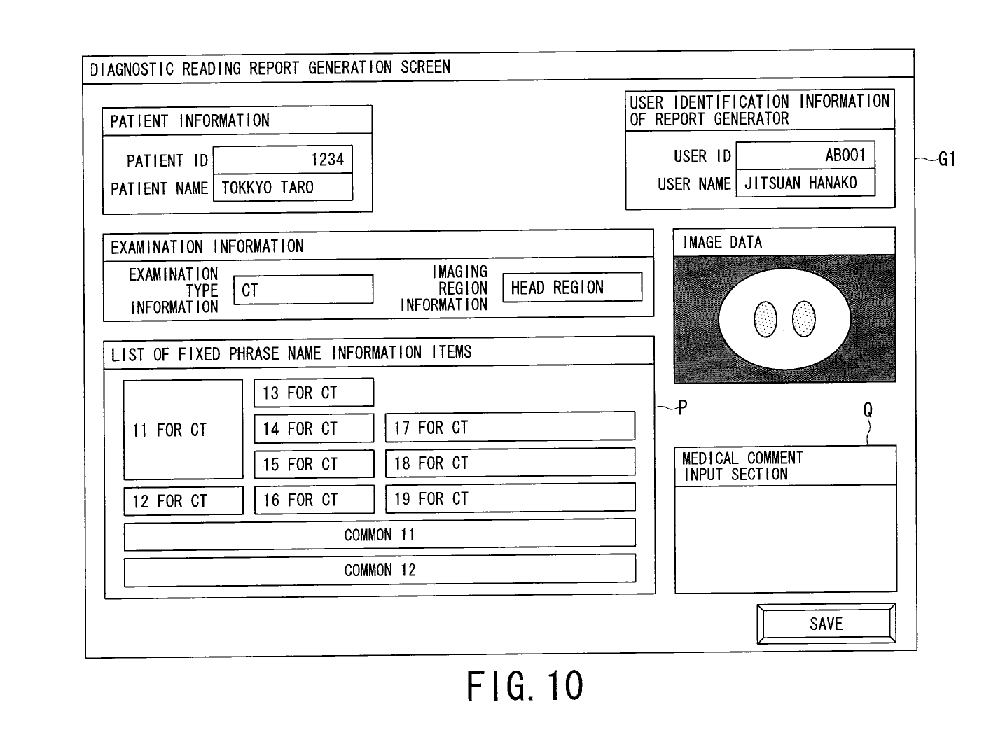

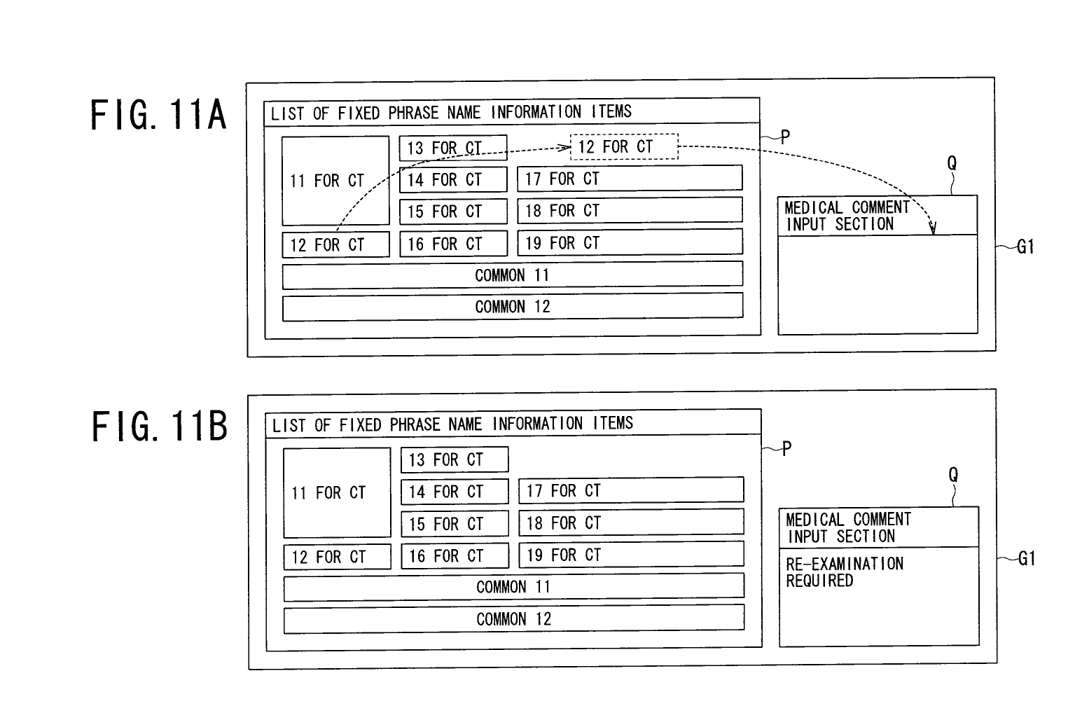

For the fifth table T5, it is discussed here that the user identification information item “AB001” and the examination type information item “CT” and the imaging region information item “head region” as the examination information are set as the conditions. In that case, a list P of fixed phrase name information items (illustrated in FIG. 10, FIG. 11A, and FIG. 11B) is generated on a diagnostic reading report generation screen. In the list P, the fixed phrase name information items “11 for CT”, “12 for CT”, and “common 11” corresponding to the fixed phrase identification information items “101”, “102”, and “106” are respectively arranged in accordance with the display position information items “0, 0”, “0, 30”, and “500, 0” so as to have sizes according to the display size information items “50 in width×20 in height”, “50×20”, and “50×20”. Then, in that case, the list P of the fixed phrase name information items is generated in a format suited to the display format information item “101”.

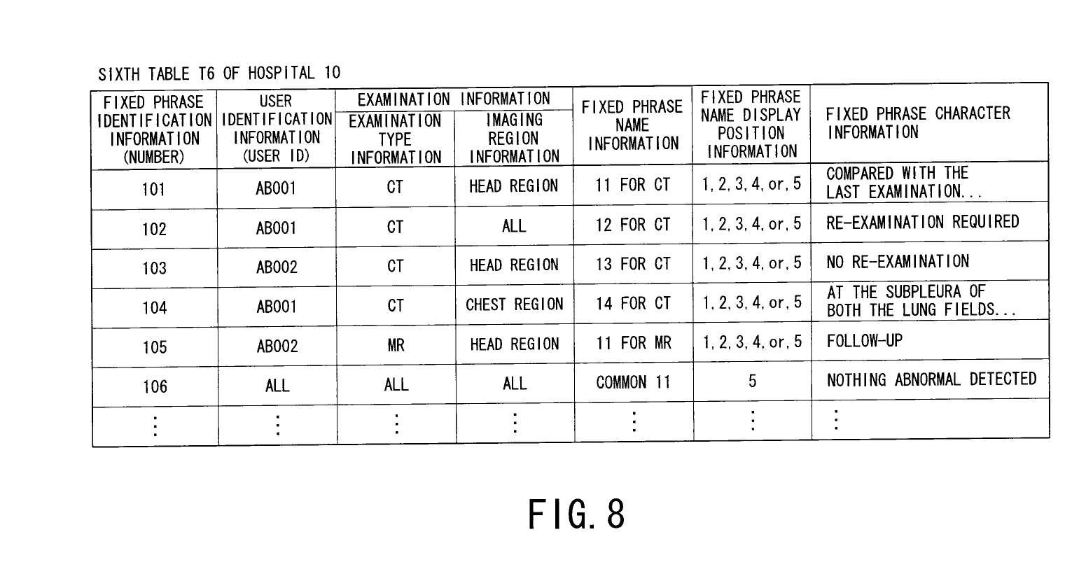

FIG. 8 is a diagram illustrating a sixth table as a modified example of the first and second tables.

The sixth table T6 illustrated in FIG. 8 is configured by the combination of the first table T1 illustrated in FIG. 3 and the second table T2 illustrated in FIG. 4, and is stored in the database 17-1 instead of the first table T1. In this case, the database 17-2 is not necessary. It is discussed here that the user identification information item “AB001” and the examination type information item “CT” and the imaging region information item “head region” as the examination information are set as the conditions. In that case, the fixed phrase identification information items “101”, “102”, and “106”, the fixed phrase name information items “11 for CT”, “12 for CT”, and “common 11”, and the fixed phrase name display position information items “1, 2, 3, 4, or 5”, “1, 2, 3, 4, or 5”, and “5” are extracted on the basis of the sixth table T6.

Note that the fixed phrase identification information and the fixed phrase name information described with reference to FIG. 3, the fixed phrase name display position information described with reference to FIG. 4, the display format information described with reference to FIG. 5, and the syntactic information described with reference to FIG. 6 may be acquired not from the databases but from particular folders in the diagnostic reading report generation supporting system 1, in the form of a file.

Note that, in the diagnostic reading report generation supporting system 1 of the first embodiment, the medical image server apparatus 12, the diagnostic reading report generation supporting apparatus 16, and the databases 17-1, 17-2, 17-3, and 17-4 are independent apparatuses. Alternatively, the diagnostic reading report generation supporting apparatus 16 may have the functions of the medical image server apparatus 12 and the databases 17-1, 17-2, 17-3, and 17-4.

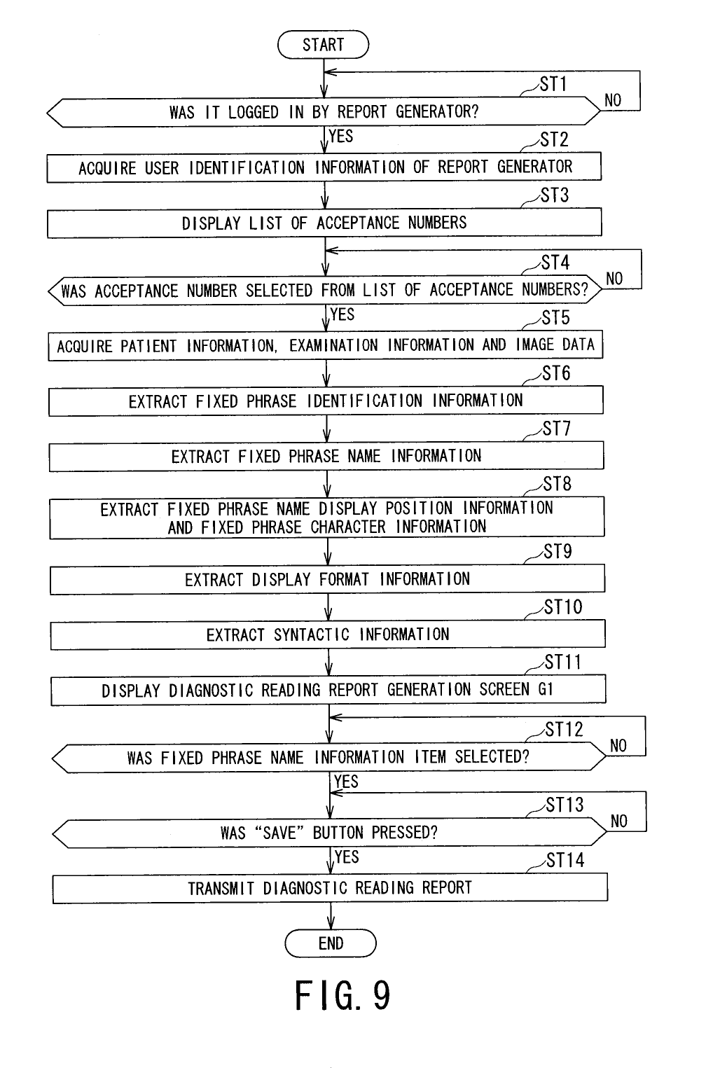

Next, an operation of the diagnostic reading report generation supporting system 1 according to the first embodiment is described with reference to a flow chart illustrated in FIG. 9.

First, the controller 41 of the diagnostic reading report generation supporting apparatus 16 illustrated in FIG. 2 determines whether or not the report generator logs in to the diagnostic reading report generation supporting apparatus 16 (Step ST1), and stands by for login by the report generator (NO in Step ST1). The report generator performs an input operation on the input device 43 of the diagnostic reading report generation supporting apparatus 16 to input login information such as a user ID and a login password, and thus logs in to the diagnostic reading report generation supporting apparatus 16.

If the controller 41 determines that the report generator logs in (YES in Step ST1), the controller 41 acquires user identification information such as the user ID of the report generator, from the inputted login information (Step ST2). Then, the controller 41 causes the display device 44 to display a list of acceptance numbers indicating medical images as the diagnostic reading targets (Step ST3). The controller 41 further determines whether or not an acceptance number is selected from the list of acceptance numbers (Step ST4), and stands by for selection of an acceptance number (NO in Step ST4). The report generator performs an input operation on the input device 43 to select an acceptance number from the list of acceptance numbers.

If the controller 41 determines that an acceptance number is selected from the list of acceptance numbers (YES in Step ST4), the controller 41 acquires patient information and examination information corresponding to the selected acceptance number from the diagnostic reading report server apparatus 13, and acquires image data corresponding to the selected acceptance number from the medical image server apparatus 12 (Step ST5). The report generator performs an input operation on the input device 43 to generate a diagnostic reading report while viewing the medical image as the diagnostic reading target.

Next, the controller 41 extracts fixed phrase identification information corresponding to the user identification information acquired in Step ST2 and the examination information acquired in Step ST5, from the first table T1 (illustrated in FIG. 3) of the database 17-1 (Step ST6), and extracts fixed phrase name information also corresponding thereto, from the first table T1 (illustrated in FIG. 3) of the database 17-1 (Step ST7). For example, in FIG. 3, extracted are the fixed phrase identification information item “101” and the fixed phrase name information item “11 for CT” each corresponding to: the user identification information item “AB001”; and the examination type information item “CT” and the imaging region information item “head region” as the examination information. Similarly, extracted are the fixed phrase identification information item “102” and the fixed phrase name information item “12 for CT” each corresponding to: the user identification information item “AB001”; and the examination type information item “CT” and the imaging region information item “ALL” as the examination information. Similarly, extracted are the fixed phrase identification information item “106” and the fixed phrase name information item “common 11” each corresponding to: a user identification information item “ALL”; and an examination type information item “ALL” and the imaging region information item “ALL” as the examination information.

The controller 41 extracts fixed phrase name display position information and fixed phrase character information each corresponding to the fixed phrase identification information extracted in Step ST6, from the second table T2 (illustrated in FIG. 4) of the database 17-2 (Step ST8). For example, in FIG. 4, extracted are the fixed phrase name display position information item “1, 2, 3, 4, or 5” and the fixed phrase character information item “Compared with the last examination . . . ” each corresponding to the fixed phrase identification information item “101”. Similarly, extracted are the fixed phrase name display position information item “1, 2, 3, 4, or 5” and the fixed phrase character information item “re-examination required” each corresponding to the fixed phrase identification information item “102”. Similarly, extracted are the fixed phrase name display position information item “5” and the fixed phrase character information item “nothing abnormal detected” each corresponding to the fixed phrase identification information item “106”.

Then, the controller 41 extracts display format information corresponding to the user identification information acquired in Step ST2, from the third table T3 (illustrated in FIG. 5) of the database 17-3 (Step ST9). For example, in FIG. 5, extracted is the display format information item “101” corresponding to the user identification information item “AB001”.

Then, the controller 41 extracts syntactic information corresponding to the display format information extracted in Step ST9, from the fourth table T4 (illustrated in FIG. 6) of the database 17-4 (Step ST10). For example, in FIG. 6, extracted is the syntactic information corresponding to the display format information item “101”.

Then, the controller 41 causes the viewer apparatus for diagnostic reading 15 to display a diagnostic reading report generation screen G1 including the list P of the fixed phrase name information items extracted in Step ST7, the patient information, the examination information, and the image data acquired in Step ST5, and the like (Step ST11).

FIG. 10 is a diagram illustrating an example of the diagnostic reading report generation screen.

FIG. 10 illustrates the diagnostic reading report generation screen G1 concerning a patient ID “1234”, in which the user identification information item “AB001” of the report generator and the examination type information item “CT” and the imaging region information item “head region” as the examination information are set as the conditions. The diagnostic reading report generation screen G1 includes the list P of the fixed phrase name information items, which is generated in a format suited to the syntactic information extracted in Step ST10. In the list P, the fixed phrase name information items that are extracted in Step ST7 on the basis of the user identification information item “AB001” and the examination type information item “CT” and the imaging region information item “head region” as the examination information set as the conditions are arranged in accordance with the fixed phrase name display position information extracted in Step ST8.

Specifically, the diagnostic reading report generation screen G1 includes the patient information (for example, a patient ID and a patient name) and the image data “CT”. The diagnostic reading report generation screen G1 includes the user identification information (for example, a user ID and a user name) of the report generator and the examination information (for example, examination type information and imaging region information), as the conditions. The diagnostic reading report generation screen G1 further includes the list P of the fixed phrase name information items (for example, 11 for CT, . . . , common 12) that are extracted in Step ST7 on the basis of the conditions. Note that the diagnostic reading report generation screen G1 is provided with a medical comment input section Q in which a medical comment sentence is to be inputted. In the case where only the fixed phrase name information items “11 for CT”, “12 for CT”, and “common 11” are extracted in Step ST7 on the basis of the conditions, only the fixed phrase name information items “11 for CT”, “12 for CT”, and “common 11” are displayed.

Returning back to the description of FIG. 9, the controller 41 determines whether or not a fixed phrase name information item is selected by the viewer apparatus for diagnostic reading 15 from the list P of the fixed phrase name information items (Step ST12), and stands by for selection of a fixed phrase name information item (NO in Step ST12). The report generator performs an input operation on an input device of the viewer apparatus for diagnostic reading 15 to attach a fixed phrase name information item included in the list P of the fixed phrase name information items to a predetermined location, and thus selects the fixed phrase name information item from the list P of the fixed phrase name information items. It is possible to use a graphical user interface (GUI) that uses many graphics to display information for the report generator on the display device and enables most basic operations to be performed using a pointing device such as a mouse as the input device 43.

FIG. 11A and FIG. 11B each illustrate part of the diagnostic reading report generation screen G1 illustrated in FIG. 10, and are views for describing a method of selecting a fixed phrase name information item from the list P of the fixed phrase name information items.

As illustrated in FIG. 11A, the report generator drags (moves) a desired fixed phrase name information item, for example, an icon of “12 for CT” from the list P of the fixed phrase name information items displayed on a display device of the viewer apparatus for diagnostic reading 15, with the use of the input device 43. Then, as illustrated in FIG. 11B, the report generator drops the dragged icon of “12 for CT” onto the medical comment input section Q. If “12 for CT” is dropped onto the medical comment input section Q, the fixed phrase character information item “re-examination required” that is extracted in Step ST8 and corresponds to “12 for CT” is displayed in the medical comment input section Q on the basis of the second table T2. Note that, if a mouse pointer is put over a fixed phrase name information item in the state illustrated in FIG. 11A, the fixed phrase character information corresponding to the fixed phrase name information item may be displayed as a pop-up window.

Returning back to the description of FIG. 9, if the controller 41 determines that a fixed phrase name information item is selected from the list P of the fixed phrase name information items (YES in Step ST12), the controller 41 determines whether or not a “save” button is pressed by the viewer apparatus for diagnostic reading 15 (Step ST13), and stands by for press of the “save” button (NO in Step ST13). The “save” button is provided on, for example, the diagnostic reading report generation screen G1. In the case of saving a diagnostic reading report after input, the report generator performs an input operation on the input device of the viewer apparatus for diagnostic reading 15 to click and press the “save” button. Note that, in the case where another button than the “save” button is pressed, processing corresponding to the another button is executed. If the controller 41 determines that the “save” button is pressed (YES in Step ST13), the controller 41 transmits the diagnostic reading report after input to the diagnostic reading report server apparatus 13 via the network Na (Step ST14), and ends the processing. Through such processing as described above, the diagnostic reading report generation supporting operation is performed.

If the report generator such as the diagnostic reader logs in to the diagnostic reading report generation supporting apparatus 16, the list P of the fixed phrase name information items corresponding to the report generator is displayed on the display device 44. The report generator performs an input operation on the input device 43 to select a fixed phrase name information item of his/her medical comment from the displayed list P of the fixed phrase name information items. In this way, a medical comment sentence is automatically inputted to a diagnostic reading report. Lastly, the report generator checks the medical comment sentence, and presses the “save” button. As a result, the diagnostic reading report after input is transmitted to the diagnostic reading report server apparatus 13.

The diagnostic reading report server apparatus 13 overwrites the diagnostic reading report before input with the diagnostic reading report transmitted from the diagnostic reading report generation supporting apparatus 16, and saves the resultant report. In response to a request from the viewer apparatus for observation 14, the saved diagnostic reading report after input is transmitted from the diagnostic reading report server apparatus 13 to the viewer apparatus for observation 14 via the network Na. As a result, the viewer apparatus for observation 14 displays the diagnostic reading report in addition to the medical image. The doctor in charge makes a diagnosis while viewing the medical image and the diagnostic reading report displayed on the viewer apparatus for observation 14.

According to the diagnostic reading report generation supporting system 1 of the first embodiment, if the report generator designates examination information, the list P of appropriate fixed phrase name information items corresponding to the report generator and the examination is displayed. Then, if the report generator selects a particular fixed phrase name information item from the list P of the fixed phrase name information items, the report generator can input fixed phrase character information corresponding to the particular fixed phrase name information item, into the medical comment input section Q. That is, according to the diagnostic reading report generation supporting system 1 of the first embodiment, only appropriate ones of a large number of fixed phrase name information items can be displayed as the list P. Hence, selection work of a fixed phrase name information item (fixed phrase character information item) is facilitated, and the generation efficiency of a diagnostic reading report by the report generator can be improved.

Further, according to the diagnostic reading report generation supporting system 1 of the first embodiment, not a list of fixed phrase character information items but the list P of the fixed phrase name information items is displayed. This eliminates the need for operations such as screen switching even if a large number of fixed phrase name information items are displayed, and hence the generation efficiency of a diagnostic reading report by the report generator can be improved.

### Second Embodiment

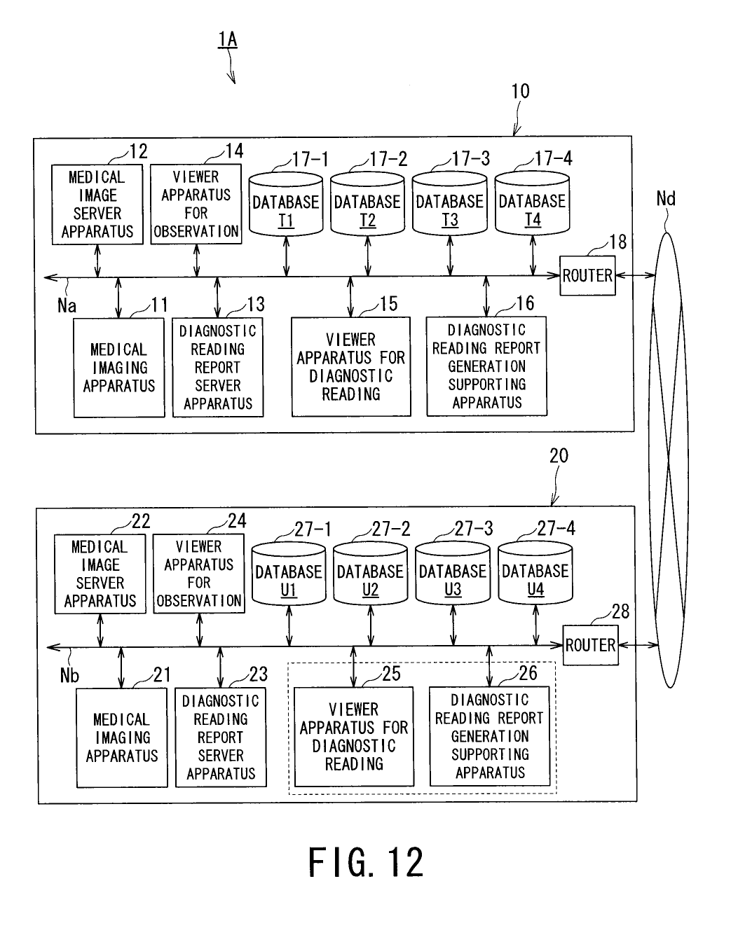

FIG. 12 is a schematic diagram illustrating a configuration of a diagnostic reading report generation supporting system according to a second embodiment.

FIG. 12 illustrates a diagnostic reading report generation supporting system 1A of the second embodiment. The diagnostic reading report generation supporting system 1A is configured by a plurality of medical institutions, for example, a first hospital 10 and a second hospital 20. The first hospital 10 includes the medical imaging apparatus 11, the medical image server apparatus 12, the diagnostic reading report server apparatus 13, the viewer apparatus for observation 14, the viewer apparatus for diagnostic reading 15, the diagnostic reading report generation supporting apparatus 16, the database group 17 (17-1 to 17-4), and a router (virtual private network (VPN)) 18. These apparatuses are mutually communicable via the network Na such as a backbone LAN. Note that the number(s) of the entirety or a part of the apparatuses 11 to 16 installed in the first hospital 10 may be more than one.

The router 18 relays data on the network Na to a network Nd such as the Internet, and relays data on the network Nd to the network Na.

Note that, in the diagnostic reading report generation supporting system 1A illustrated in FIG. 12, the same elements as those in the diagnostic reading report generation supporting system 1 illustrated in FIG. 1 are denoted by the same reference signs, and description thereof is omitted.

Similarly to the first hospital 10, the second hospital 20 includes a medical imaging apparatus 21, a medical image server apparatus 22, a diagnostic reading report server apparatus 23, a viewer apparatus for observation 24, a viewer apparatus for diagnostic reading 25, a diagnostic reading report generation supporting apparatus 26, a database group 27 (27-1 to 27-4), and a router 28. These apparatuses are mutually communicable via a network Nb such as a backbone LAN. Note that the number(s) of the entirety or a part of the apparatuses 21 to 26 installed in the second hospital 20 may be more than one.

The medical imaging apparatus 21 has the same configuration and function as those of the medical imaging apparatus 11, the medical image server apparatus 22 has the same configuration and function as those of the medical image server apparatus 12, the diagnostic reading report server apparatus 23 has the same configuration and function as those of the diagnostic reading report server apparatus 13, the viewer apparatus for observation 24 has the same configuration and function as those of the viewer apparatus for observation 14, and the viewer apparatus for diagnostic reading 25 has the same configuration and function as those of the viewer apparatus for diagnostic reading 15.

The diagnostic reading report generation supporting apparatus 26 has the same configuration as that of the diagnostic reading report generation supporting apparatus 16 illustrated in FIG. 2. The function (operation) of the diagnostic reading report generation supporting apparatus 26 is described later.

The database 27-1 stores a first table U1. In the first table U1, fixed phrase identification information is associated with the combination of user identification information, examination information, and fixed phrase name information.

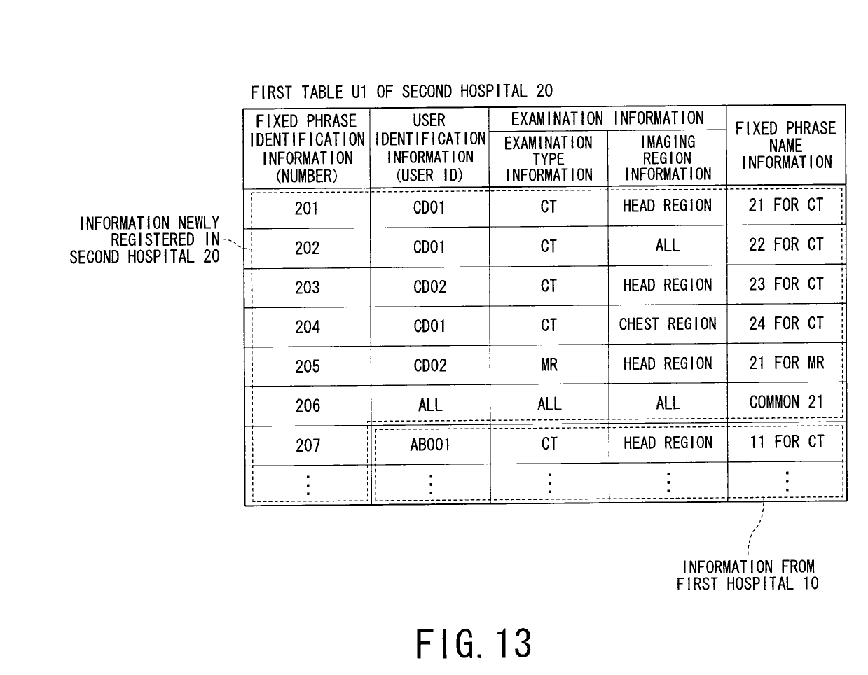

FIG. 13 is a diagram illustrating an example of the first table U1 managed by the database 27-1.

As illustrated in FIG. 13, in the first table U1, a fixed phrase identification information item “201” is associated with the combination of: a user identification information item “CD01”; the examination type information item “CT” and the imaging region information item “head region” as the examination information; and a fixed phrase name information item “21 for CT”. Similarly, in the first table U1, a fixed phrase identification information item “202” is associated with the combination of: the user identification information item “CD01”; the examination type information item “CT” and the imaging region information item “ALL” as the examination information; and a fixed phrase name information item “22 for CT”. Note that, for the six rows from the top in the first table U1 illustrated in FIG. 13, the user identification information, the examination information, the fixed phrase name information, and the fixed phrase identification information are all newly registered in the second hospital 20.

In the first table U1, a fixed phrase identification information item “207” is associated with the combination of: the user identification information item “AB001”; the examination type information item “CT” and the imaging region information item “head region” as the examination information; and the fixed phrase name information item “11 for CT”. Note that, for the two rows from the bottom in the first table U1 illustrated in FIG. 13, the user identification information, the examination information, and the fixed phrase name information are provided from the first hospital 10, and the fixed phrase identification information is newly registered in the second hospital 20.

Here, the user identification information unique to the first hospital 10 is used in the first hospital 10, and the user identification information unique to the second hospital 20 is used in the second hospital 20. Accordingly, even different user identification information items may correspond to the same user. For example, in the second hospital 20, the user identification information item “AB001” in the first hospital 10 is determined as being the same as the user identification information item “CD01”. According to a method for such determination, in the case where a user name corresponding to the user identification information item “AB001” and a user name corresponding to the user identification information item “CD01” are coincident with each other, the user identification information item “AB001” and the user identification information item “CD01” are determined as being the same as each other. According to another method for such determination, a correspondence table between the user ID of the user identification information in the first hospital 10 and the user ID of the user identification information in the second hospital 20 is provided, and in the case where the user identification information item “AB001” corresponds to the user identification information item “CD01”, the user identification information item “AB001” and the user identification information item “CD01” are determined as being the same as each other.

Note that user identification information unified between the first hospital 10 and the second hospital 20 may be used. Particularly in the case where the first hospital 10 and the second hospital 20 are affiliated hospitals, user identification information unified between the first hospital 10 and the second hospital 20 is used. For example, in the case where the user identification information item “CD01” is coincident with the user identification information item “AB001”, the user identification information item “AB001” illustrated in FIG. 13 is replaced with the user identification information item “CD01”.

It is discussed here that, in the first table U1, the user identification information item “CD01” (and “AB001” equated therewith) and the examination type information item “CT” and the imaging region information item “head region” as the examination information are set as the conditions. In that case, the fixed phrase identification information items “201”, “202”, “206”, and “207” and the fixed phrase name information items “21 for CT”, “22 for CT”, “common 21”, and “11 for CT” are extracted on the basis of the first table U1 illustrated in FIG. 13.

Returning back to the description of FIG. 12, the database 27-2 stores a second table U2. In the second table U2, fixed phrase identification information is associated with the combination of: fixed phrase name display position information indicating a display position of fixed phrase name information; and fixed phrase character information that is character information of a fixed phrase.

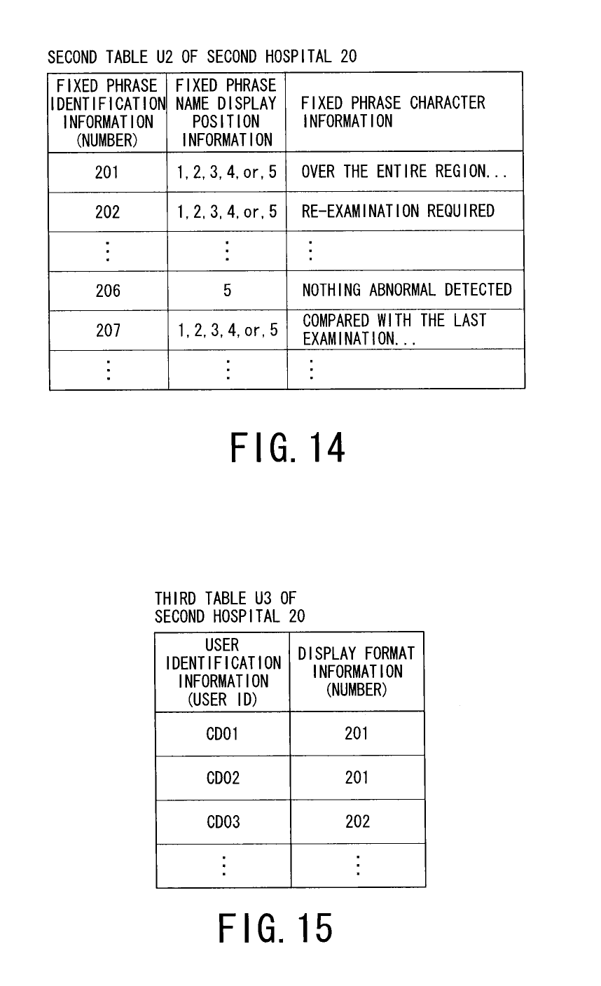

FIG. 14 is a diagram illustrating an example of the second table U2 managed by the database 27-2.

As illustrated in FIG. 14, in the second table U2, the fixed phrase identification information item “201” is associated with the combination of: the fixed phrase name display position information item “1, 2, 3, 4, or 5”; and a fixed phrase character information item “over the entire region . . . ”. That is, the fixed phrase identification information item “201” may be displayed at the position of the fixed phrase name display position information item “1”, and may be displayed at the position of the fixed phrase name display position information item “5”. It is discussed here that the user identification information item “CD01” (and “AB001” equated therewith) and the examination type information item “CT” and the imaging region information item “head region” as the examination information are set as the conditions. In that case, the fixed phrase identification information items “201”, “202”, “206”, and “207” and the fixed phrase name information items “21 for CT”, “22 for CT”, “common 21”, and “11 for CT” are extracted on the basis of the first table U1 illustrated in FIG. 13. Further, the fixed phrase name display position information items “1, 2, 3, 4, or 5”, “1, 2, 3, 4, or 5”, “5”, and “1, 2, 3, 4, or 5” and the fixed phrase character information items “over the entire region . . . ”, “re-examination required”, “nothing abnormal detected”, and “Compared with the last examination . . . ” corresponding to the extracted fixed phrase identification information items “201”, “202”, “206”, and “207” are extracted on the basis of the second table U2 illustrated in FIG. 14.

The fixed phrase name display position information and the fixed phrase character information are provided from the first hospital 10, and the fixed phrase identification information are newly registered in the second hospital 20. That is, the fixed phrase name display position information item “1, 2, 3, 4, or 5” and the fixed phrase character information item “Compared with the last examination . . . ” each correspond to the fixed phrase identification information item “101” in the first hospital 10 (see FIG. 4), whereas these information items each correspond to the fixed phrase identification information item “207” in the second hospital 20.

Returning back to the description of FIG. 12, the database 27-3 stores a third table U3. In the third table U3, user identification information is associated with display format information for displaying a fixed phrase.

FIG. 15 is a diagram illustrating an example of the third table U3 managed by the database 27-3.

It is discussed here that the user identification information item “CD01” and the examination type information item “CT” and the imaging region information item “head region” as the examination information are set as the conditions. In that case, a display format information item “201” corresponding to the user identification information item “CD01” is extracted on the basis of the third table U3 illustrated in FIG. 15.

Returning back to the description of FIG. 12, the database 27-4 stores a fourth table U4. In the fourth table U4, display format information is associated with syntactic information.

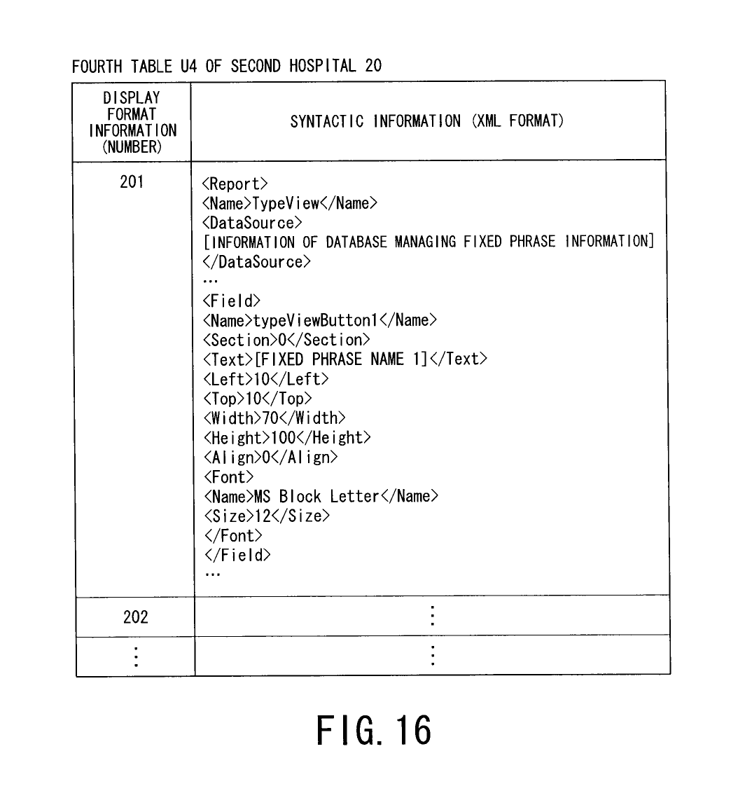

FIG. 16 is a diagram illustrating an example of the fourth table U4 managed by the database 27-4.

It is discussed here that the user identification information item “CD01” and the examination type information item “CT” and the imaging region information item “head region” as the examination information are set as the conditions. In that case, the display format information item “201” is extracted on the basis of the third table U3 illustrated in FIG. 15. Further, syntactic information corresponding to the extracted display format information item “201” is extracted on the basis of the fourth table U4 illustrated in FIG. 16.

Note that, in the diagnostic reading report generation supporting system 1A of the second embodiment, the medical image server apparatus 12, the diagnostic reading report generation supporting apparatus 16, and the databases 17-1, 17-2, 17-3, and 17-4 are independent apparatuses. Alternatively, the diagnostic reading report generation supporting apparatus 16 may have the functions of the medical image server apparatus 12 and the databases 17-1, 17-2, 17-3, and 17-4. Similarly, the diagnostic reading report generation supporting apparatus 26 may have the functions of the medical image server apparatus 22 and the databases 27-1, 27-2, 27-3, and 27-4.

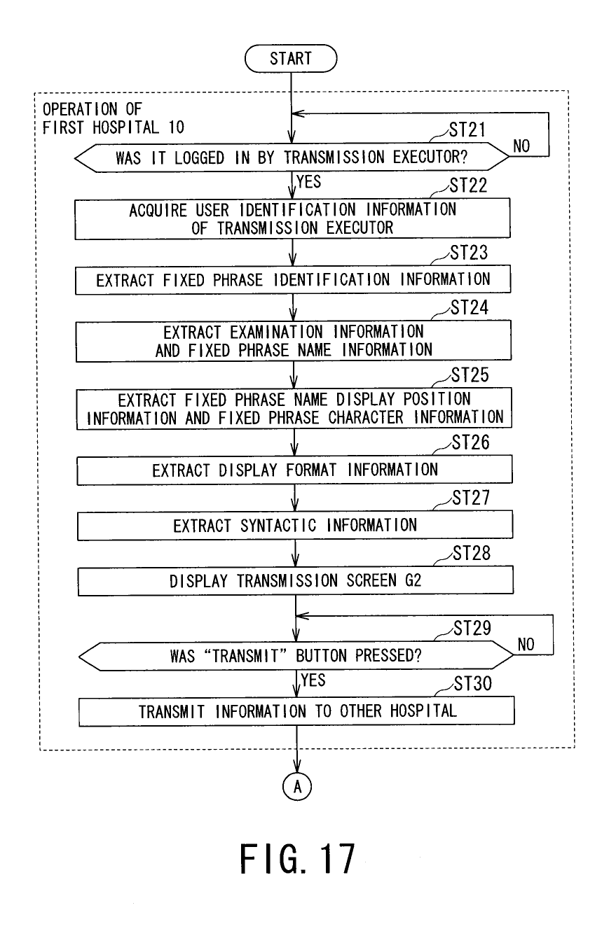

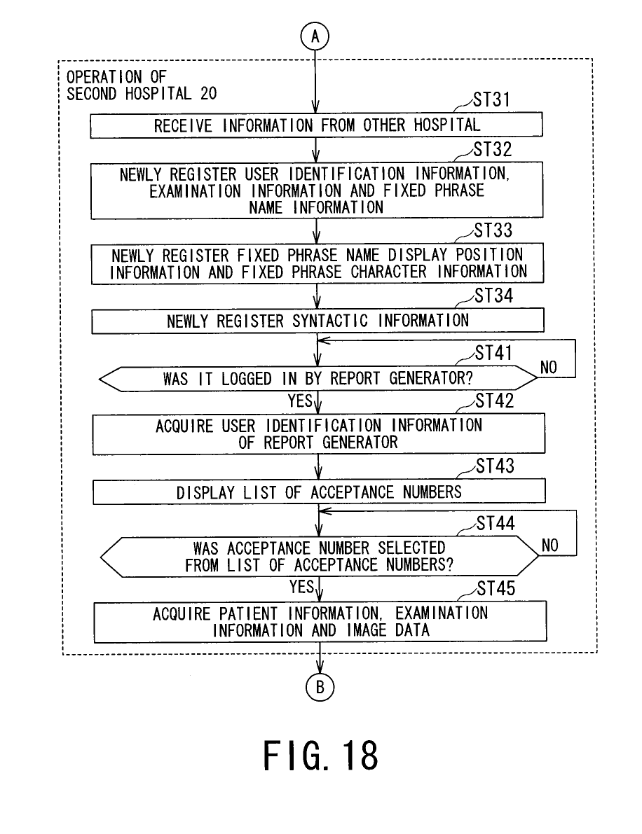

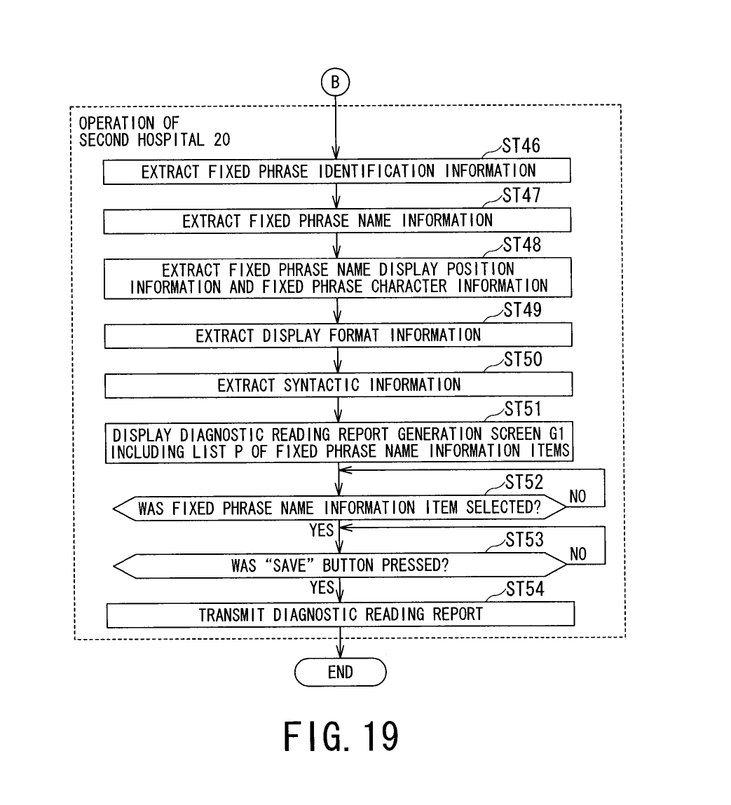

Next, an operation of the diagnostic reading report generation supporting system 1A according to the second embodiment is described with reference to a flow chart illustrated in FIG. 17 to FIG. 19.

First, the controller 41 of the diagnostic reading report generation supporting apparatus 16 illustrated in FIG. 2 determines whether or not a transmission executor logs in to the diagnostic reading report generation supporting apparatus 16 (Step ST21), and stands by for login by the transmission executor (NO in Step ST21). The transmission executor performs an input operation on the input device 43 of the diagnostic reading report generation supporting apparatus 16 to input login information such as a user ID and a login password, and thus logs in to the diagnostic reading report generation supporting apparatus 16.

If the controller 41 determines that the transmission executor logs in (YES in Step ST21), the controller 41 of the diagnostic reading report generation supporting apparatus 16 acquires user identification information such as the user ID of the transmission executor, from the inputted login information (Step ST22). Then, the controller 41 of the diagnostic reading report generation supporting apparatus 16 extracts fixed phrase identification information corresponding to the user identification information acquired in Step ST22, from the first table T1 (illustrated in FIG. 3) of the database 17-1 (Step ST23), and extracts examination information and fixed phrase name information also corresponding thereto, from the first table T1 (illustrated in FIG. 3) of the database 17-1 (Step ST24). For example, in FIG. 3, extracted are the fixed phrase identification information item “101”, the examination type information item “CT” and the imaging region information item “head region” as the examination information, and the fixed phrase name information item “11 for CT” each corresponding to the user identification information item “AB001”. Similarly, extracted are the fixed phrase identification information item “102”, the examination type information item “CT” and the imaging region information item “ALL” as the examination information, and the fixed phrase name information item “12 for CT” each corresponding to the user identification information item “AB001”. Similarly, extracted are the fixed phrase identification information item “104”, the examination type information item “CT” and an imaging region information item “chest region” as the examination information, and a fixed phrase name information item “14 for CT” each corresponding to the user identification information item “AB001”. In addition, extracted are the fixed phrase identification information item “106”, the examination type information item “ALL” and the imaging region information item “ALL” as the examination information, and the fixed phrase name information item “common 11” each corresponding to the user identification information item “ALL” including the user identification information item “AB001”.

The controller 41 of the diagnostic reading report generation supporting apparatus 16 extracts fixed phrase name display position information and fixed phrase character information each corresponding to the fixed phrase identification information extracted in Step ST23, from the second table T2 (illustrated in FIG. 4) of the database 17-2 (Step ST25). For example, in FIG. 4, extracted are the fixed phrase name display position information item “1, 2, 3, 4, or 5” and the fixed phrase character information item “Compared with the last examination . . . ” each corresponding to the fixed phrase identification information item “101”. Similarly, extracted are the fixed phrase name display position information item “1, 2, 3, 4, or 5” and the fixed phrase character information item “re-examination required” each corresponding to the fixed phrase identification information item “102”. Similarly, extracted are the fixed phrase name display position information item “1, 2, 3, 4, or 5” and a fixed phrase character information item “At the subpleura of both the lung fields . . . ” each corresponding to the fixed phrase identification information item “104”. Extracted are the fixed phrase name display position information item “5” and the fixed phrase character information item “nothing abnormal detected” each corresponding to the fixed phrase identification information item “106”.

Then, the controller 41 of the diagnostic reading report generation supporting apparatus 16 extracts display format information corresponding to the user identification information acquired in Step ST22, from the third table T3 (illustrated in FIG. 5) of the database 17-3 (Step ST26). For example, in FIG. 5, extracted is the display format information item “101” corresponding to the user identification information item “AB001”.

Then, the controller 41 of the diagnostic reading report generation supporting apparatus 16 extracts syntactic information corresponding to the display format information extracted in Step ST26, from the fourth table T4 (illustrated in FIG. 6) of the database 17-4 (Step ST27). For example, in FIG. 6, extracted is the syntactic information corresponding to the display format information item “101”.

Then, the controller 41 of the diagnostic reading report generation supporting apparatus 16 causes the display device 44 of the diagnostic reading report generation supporting apparatus 16 in the first hospital 10 to display, as an information display screen, the examination information and the fixed phrase name information extracted in Step ST24, the fixed phrase name display position information and the fixed phrase character information extracted in Step ST25, and the syntactic information extracted in Step ST27 (Step ST28).

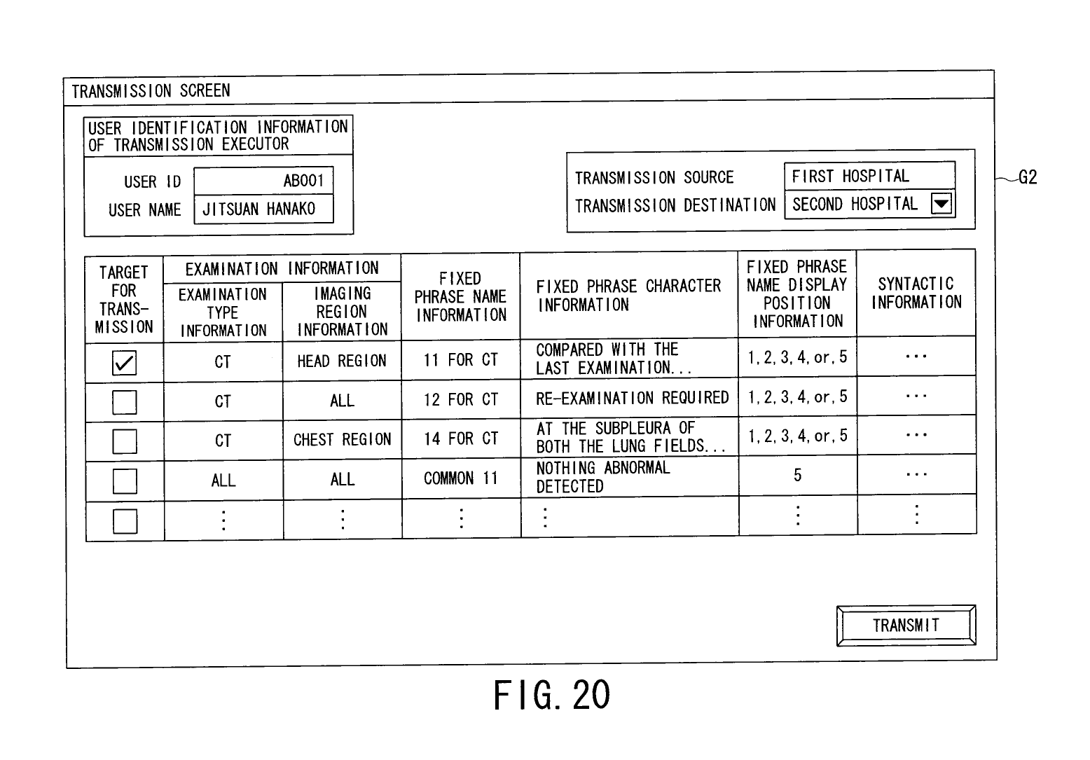

FIG. 20 is a diagram illustrating an example of a transmission screen.

FIG. 20 illustrates a transmission screen G2, in which the user identification information item “AB001” of the transmission executor is set as the condition. Specifically, the transmission screen G2 includes an information transmission source and an information transmission destination. The transmission screen G2 includes the user identification information (for example, a user ID and a user name) of the transmission executor, as the condition. The transmission screen G2 also includes: the examination information (for example, examination type information and imaging region information) and the fixed phrase name information extracted in Step ST24; the fixed phrase name display position information and the fixed phrase character information extracted in Step ST25; and the syntactic information extracted in Step ST27 on the basis of the condition. The transmission executor selects an information transmission destination, and checks information to be transmitted, with the use of the input device 43 of the diagnostic reading report generation supporting apparatus 16.

Note that, in the present embodiment, description is given of the case where the transmission screen is generated with the user identification information of the transmission executor being set as the condition, but the present invention is not limited thereto. For example, the transmission screen may be generated with the user identification information of the transmission executor and the examination information being set as the conditions.

Returning back to the description of FIG. 17, the controller 41 of the diagnostic reading report generation supporting apparatus 16 determines whether or not a “transmit” button is pressed (Step ST29), and stands by for press of the “transmit” button (NO in Step ST29). The “transmit” button is provided on, for example, the transmission screen G2. In the case of transmitting, to the second hospital 20 that is another hospital, the user identification information of the transmission executor, the examination information, the fixed phrase name information, the fixed phrase name display position information, the fixed phrase character information, and the syntactic information in association with one another, the transmission executor performs an input operation on the input device 43 of the diagnostic reading report generation supporting apparatus 16 to click and press the “transmit” button. If the controller 41 determines that the “transmit” button is pressed (YES in Step ST29), information in which the user identification information of the transmission executor, the examination information, the fixed phrase name information, the fixed phrase name display position information, the fixed phrase character information, and the syntactic information are associated with one another is exported and transmitted to the second hospital 20 via the router 18 and the network Nd (Step ST30).

Subsequently, the second hospital 20 that is another hospital receives the user identification information, the examination information, the fixed phrase name information, the fixed phrase name display position information, the fixed phrase character information, and the syntactic information that are transmitted by the first hospital 10 in Step ST30, via the network Nd and the router 28 (Step ST31). The second hospital 20 imports the information received in Step ST31 into the first table U1 (illustrated in FIG. 13), and newly registers thereto the user identification information, the examination information, and the fixed phrase name information together with fixed phrase identification information assigned thereto (Step ST32). For example, as illustrated in FIG. 13, the user identification information item “AB001”, the examination type information item “CT” and the imaging region information item “head region” as the examination information, and the fixed phrase name information item “11 for CT” that are received in Step ST31 are newly registered to the first table U1 together with the fixed phrase identification information item “207” assigned thereto.

Then, the second hospital 20 newly registers the fixed phrase name display position information and the fixed phrase character information that are received in Step ST31 and imported, to fixed phrase identification information in the second table U2 (illustrated in FIG. 14) (Step ST33). For example, as illustrated in FIG. 14, the fixed phrase name display position information item “1, 2, 3, 4, or 5” and the fixed phrase character information item “Compared with the last examination . . . ” that are received in Step ST31 are newly registered to the fixed phrase identification information item “207” in the second table U2.

Further, the second hospital 20 newly registers the syntactic information received in Step ST31 to the fourth table U4 (illustrated in FIG. 16) on the basis of user identification information of the third table U3 (illustrated in FIG. 15) (Step ST34).

Through Steps ST32 to ST34, as illustrated in FIG. 13 to FIG. 16, the databases 27-1 to 27-4 in the second hospital 20 can have the tables U1 to U4 that share the information registered in the first hospital 10 and the information registered in the second hospital 20.

The controller 41 of the diagnostic reading report generation supporting apparatus 26 in the second hospital 20 determines whether or not the report generator (transmission executor) logs in to the diagnostic reading report generation supporting apparatus 26 (Step ST41), and stands by for login by the report generator (NO in Step ST41). The report generator performs an input operation on the input device 43 of the diagnostic reading report generation supporting apparatus 26 to input login information such as a user ID and a login password, and thus logs in to the diagnostic reading report generation supporting apparatus 26.

If the controller 41 determines that the report generator logs in (YES in Step ST41), the controller 41 of the diagnostic reading report generation supporting apparatus 26 acquires user identification information such as the user ID of the report generator, from the inputted login information (Step ST42). Then, the controller 41 of the diagnostic reading report generation supporting apparatus 26 causes the display device 44 of the diagnostic reading report generation supporting apparatus 26 to display a list of acceptance numbers indicating medical images as the diagnostic reading targets (Step ST43). The controller 41 of the diagnostic reading report generation supporting apparatus 26 further determines whether or not an acceptance number is selected from the list of acceptance numbers (Step ST44), and stands by for selection of an acceptance number (NO in Step ST44). The report generator performs an input operation on the input device 43 of the diagnostic reading report generation supporting apparatus 26 to select an acceptance number from the list of acceptance numbers.

If the controller 41 determines that an acceptance number is selected from the list of acceptance numbers (YES in Step ST44), the controller 41 of the diagnostic reading report generation supporting apparatus 26 acquires patient information and examination information corresponding to the selected acceptance number from the diagnostic reading report server apparatus 23, and acquires image data corresponding to the selected acceptance number from the medical image server apparatus 22 (Step ST45). The report generator in the second hospital 20 performs an input operation on the input device 43 of the diagnostic reading report generation supporting apparatus 26 to generate a diagnostic reading report while viewing the medical image as the diagnostic reading target.

Next, the controller 41 of the diagnostic reading report generation supporting apparatus 26 extracts fixed phrase identification information corresponding to the user identification information acquired in Step ST42 and the examination information acquired in Step ST45, from the first table U1 (illustrated in FIG. 13) of the database 27-1 (Step ST46), and extracts fixed phrase name information also corresponding thereto, from the first table U1 (illustrated in FIG. 13) of the database 27-1 (Step ST47). For example, in FIG. 13, extracted are the fixed phrase identification information item “201” and the fixed phrase name information item “21 for CT” each corresponding to: the user identification information item “CD01”; and the examination type information item “CT” and the imaging region information item “head region” as the examination information. Similarly, extracted are the fixed phrase identification information item “202” and the fixed phrase name information item “22 for CT” each corresponding to: the user identification information item “CD01”; and the examination type information item “CT” and the imaging region information item “ALL” as the examination information. Similarly, extracted are the fixed phrase identification information item “206” and the fixed phrase name information item “common 21” each corresponding to: the user identification information item “ALL”; and the examination type information item “ALL” and the imaging region information item “ALL” as the examination information. In addition, extracted are the fixed phrase identification information item “207” and the fixed phrase name information item “11 for CT” each corresponding to: the user identification information item “AB001” equated with “CD01”; and the examination type information item “CT” and the imaging region information item “head region” as the examination information.

The controller 41 of the diagnostic reading report generation supporting apparatus 26 extracts fixed phrase name display position information and fixed phrase character information each corresponding to the fixed phrase identification information extracted in Step ST46, from the second table U2 (illustrated in FIG. 14) of the database 27-2 (Step ST48). For example, in FIG. 14, extracted are the fixed phrase name display position information item “1, 2, 3, 4, or 5” and the fixed phrase character information item “over the entire region . . . ” each corresponding to the fixed phrase identification information item “201”. Similarly, extracted are the fixed phrase name display position information item “1, 2, 3, 4, or 5” and the fixed phrase character information item “re-examination required” each corresponding to the fixed phrase identification information item “202”. Similarly, extracted are the fixed phrase name display position information item “5” and the fixed phrase character information item “nothing abnormal detected” each corresponding to the fixed phrase identification information item “206”. In addition, extracted are the fixed phrase name display position information item “1, 2, 3, 4, or 5” and the fixed phrase character information item “Compared with the last examination . . . ” each corresponding to the fixed phrase identification information item “207”.

Then, the controller 41 of the diagnostic reading report generation supporting apparatus 26 extracts display format information corresponding to the user identification information acquired in Step ST42, from the third table U3 (illustrated in FIG. 15) of the database 27-3 (Step ST49). For example, in FIG. 15, extracted is the display format information item “201” corresponding to the user identification information item “CD01”.

Then, the controller 41 of the diagnostic reading report generation supporting apparatus 26 extracts syntactic information corresponding to the display format information extracted in Step ST49, from the fourth table U4 (illustrated in FIG. 16) of the database 27-4 (Step ST50). For example, in FIG. 16, extracted is the syntactic information corresponding to the display format information item “201”.

Then, the controller 41 of the diagnostic reading report generation supporting apparatus 26 causes the viewer apparatus for diagnostic reading 25 to display a diagnostic reading report generation screen including the list P of the fixed phrase name information items extracted in Step ST47, the patient information, the examination information, and the image data acquired in Step ST45, and the like (Step ST51). The diagnostic reading report generation screen displayed in Step ST51 is equivalent to that illustrated in FIG. 10.

The controller 41 of the diagnostic reading report generation supporting apparatus 26 determines whether or not a fixed phrase name information item is selected by the viewer apparatus for diagnostic reading 25 from the list P of the fixed phrase name information items (Step ST52), and stands by for selection of a fixed phrase name information item (NO in Step ST52). The report generator performs an input operation on an input device of the viewer apparatus for diagnostic reading 25 to attach a fixed phrase name information item included in the list P of the fixed phrase name information items to a predetermined location, and thus selects the fixed phrase name information item from the list P of the fixed phrase name information items. The method of selecting a fixed phrase name information item from the list P of the fixed phrase name information items is equivalent to that described with reference to FIG. 11A and FIG. 11B.

If the controller 41 determines that a fixed phrase name information item is selected from the list P of the fixed phrase name information items (YES in Step ST52), the controller 41 of the diagnostic reading report generation supporting apparatus 26 determines whether or not the “save” button is pressed by the viewer apparatus for diagnostic reading 25 (Step ST53), and stands by for press of the “save” button (NO in Step ST53). In the case of saving a diagnostic reading report after input, the report generator performs an input operation on the input device of the viewer apparatus for diagnostic reading 25 to click and press the “save” button. Note that, in the case where another button than the “save” button is pressed, processing corresponding to the another button is executed. If the controller 41 determines that the “save” button is pressed (YES in Step ST53), the controller 41 transmits the diagnostic reading report after input to the diagnostic reading report server apparatus 23 via the network Nb (Step ST54), and ends the processing. Through such processing as described above, the diagnostic reading report generation supporting operation is performed.

According to the diagnostic reading report generation supporting system 1A of the second embodiment, if the report generator designates examination information, the list P of appropriate fixed phrase name information items corresponding to the report generator and the examination is displayed, the fixed phrase name information items being generated not only in the second hospital 20 in which the report is generated but also in the first hospital 10. Then, if the report generator selects a particular fixed phrase name information item from the list P of the fixed phrase name information items, the report generator can input fixed phrase character information corresponding to the particular fixed phrase name information item, into the medical comment input section Q. That is, according to the diagnostic reading report generation supporting system 1A of the second embodiment, only appropriate ones of a large number of fixed phrase name information items that are generated not only in the second hospital 20 but also in the first hospital 10 can be displayed as the list P. Hence, selection work of a fixed phrase name information item (fixed phrase character information item) is facilitated, and the generation efficiency of a diagnostic reading report by the report generator can be improved.

Further, according to the diagnostic reading report generation supporting system 1A of the second embodiment, not a list of fixed phrase character information items but the list P of the fixed phrase name information items is displayed. This eliminates the need for operations such as screen switching even if a large number of fixed phrase name information items are displayed, and hence the generation efficiency of a diagnostic reading report by the report generator can be improved.

Furthermore, according to the diagnostic reading report generation supporting system 1A of the second embodiment, even in the case where a given report generator makes a diagnostic reading in different hospitals (the first hospital 10 and the second hospital 20), the given report generator can use fixed phrase character information and the like used in the first hospital 10, also in the second hospital 20, and hence the generation efficiency of a diagnostic reading report by the report generator can be improved.

### Third Embodiment

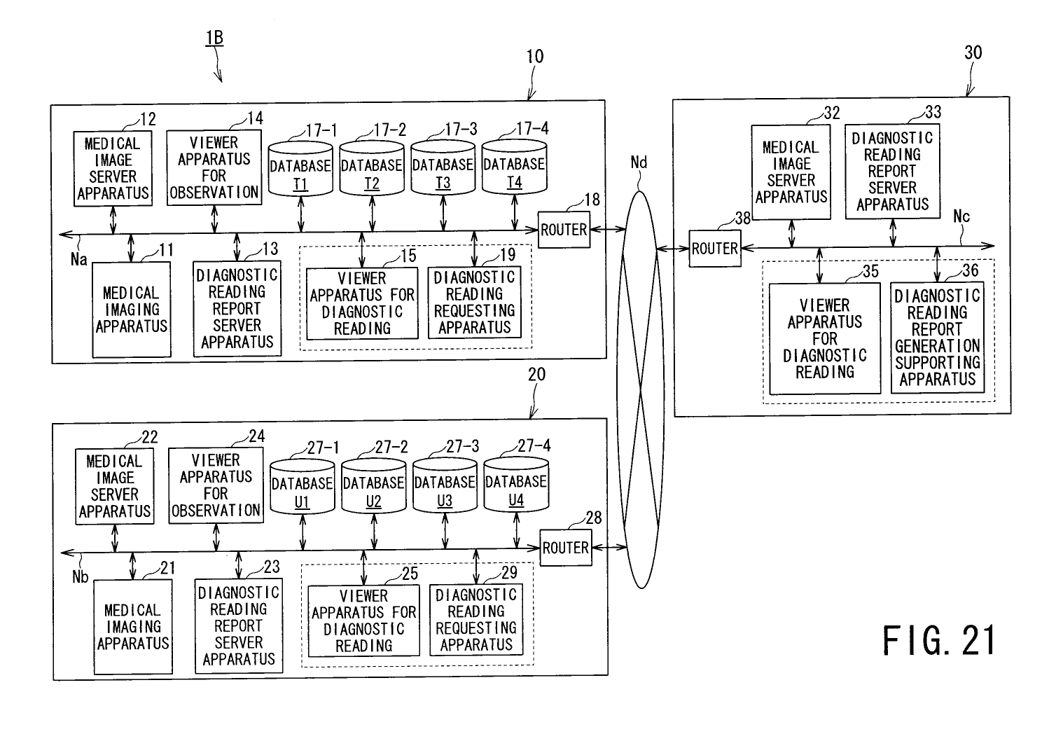

FIG. 21 is a schematic diagram illustrating a configuration of a diagnostic reading report generation supporting system according to a third embodiment.

FIG. 21 illustrates a diagnostic reading report generation supporting system 1B of the third embodiment. The diagnostic reading report generation supporting system 1B is configured by a plurality of medical institutions, for example, the first hospital 10, the second hospital 20, and a diagnostic reading center 30. The first hospital 10 includes the medical imaging apparatus 11, the medical image server apparatus 12, the diagnostic reading report server apparatus 13, the viewer apparatus for observation 14, the viewer apparatus for diagnostic reading 15, the database group 17 (17-1 to 17-4), the router 18, and a diagnostic reading requesting apparatus 19. These apparatuses are mutually communicable via the network Na such as a backbone LAN. Note that the number(s) of the entirety or a part of the apparatuses 11 to 15 and 17 to 19 installed in the first hospital 10 may be more than one.

The diagnostic reading requesting apparatus 19 has the same configuration as that of the diagnostic reading report generation supporting apparatus 16 illustrated in FIG. 2. The function (operation) of the diagnostic reading requesting apparatus 19 is described later.

The second hospital 20 includes the medical imaging apparatus 21, the medical image server apparatus 22, the diagnostic reading report server apparatus 23, the viewer apparatus for observation 24, the viewer apparatus for diagnostic reading 25, the database group 27 (27-1 to 27-4), the router 28, and a diagnostic reading requesting apparatus 29. These apparatuses are mutually communicable via the network Nb such as a backbone LAN. Note that the number(s) of the entirety or a part of the apparatuses 21 to 25 and 27 to 29 installed in the second hospital 20 may be more than one.

The diagnostic reading requesting apparatus 29 has the same configuration as that of the diagnostic reading report generation supporting apparatus 16 illustrated in FIG. 2. The function (operation) of the diagnostic reading requesting apparatus 29 is described later.

Note that, in the diagnostic reading report generation supporting system 1B illustrated in FIG. 21, the same elements as those in the diagnostic reading report generation supporting system 1 illustrated in FIG. 1 or the diagnostic reading report generation supporting system 1A illustrated in FIG. 12 are denoted by the same reference signs, and description thereof is omitted.

The diagnostic reading center 30 includes a medical image server apparatus 32, a diagnostic reading report server apparatus 33, a viewer apparatus for diagnostic reading 35, a diagnostic reading report generation supporting apparatus 36, and a router 38. These apparatuses are mutually communicable via a network Nc such as a backbone LAN. Note that the number(s) of the entirety or a part of the apparatuses 32, 33, 35, and 36 installed in the diagnostic reading center 30 may be more than one.

The medical image server apparatus 32 stores image data contained in diagnostic reading request information transmitted from each of the first hospital 10 and the second hospital 20. The medical image server apparatus 32 provides the image data to the viewer apparatus for diagnostic reading 35 in response to a request from the viewer apparatus for diagnostic reading 35. In the case of storing the image data, the medical image server apparatus 32 transmits supplementary information attached to the image data to the diagnostic reading report server apparatus 33. The supplementary information contains an acceptance number, patient information, examination information, and the like.

The diagnostic reading report server apparatus 33 receives the supplementary information from the medical image server apparatus 32, and stores a diagnostic reading report before input including the received supplementary information, in association with its acceptance number. Then, the diagnostic reading report server apparatus 33 provides the diagnostic reading report before input to the diagnostic reading report generation supporting apparatus 36 in response to a request from the diagnostic reading report generation supporting apparatus 36. The diagnostic reading report server apparatus 33 stores as appropriate a diagnostic reading report after input generated by the diagnostic reader.

The viewer apparatus for diagnostic reading 35 displays the medical image stored in the medical image server apparatus 32, the diagnostic reading report before input stored in the diagnostic reading report server apparatus 33, and the like. The viewer apparatus for diagnostic reading 35 is installed in, for example, a diagnostic reading room in the hospital, and provides the medical image to the report generator such as the diagnostic reader who generates the diagnostic reading report. The viewer apparatus for diagnostic reading 35 enables the report generator to view the medical image as the diagnostic reading target.

The diagnostic reading report generation supporting apparatus 36 has the same configuration as that of the diagnostic reading report generation supporting apparatus 16 illustrated in FIG. 2. The function (operation) of the diagnostic reading report generation supporting apparatus 36 is described later.

Note that, in the diagnostic reading report generation supporting system 1B of the third embodiment, the medical image server apparatus 12, the databases 17-1, 17-2, 17-3, and 17-4, and the diagnostic reading requesting apparatus 19 are independent apparatuses. Alternatively, the diagnostic reading requesting apparatus 19 may have the functions of the medical image server apparatus 12 and the databases 17-1, 17-2, 17-3, and 17-4. Similarly, the diagnostic reading requesting apparatus 29 may have the functions of the medical image server apparatus 22 and the databases 27-1, 27-2, 27-3, and 27-4. Similarly, the diagnostic reading report generation supporting apparatus 36 may have the function of the medical image server apparatus 32.

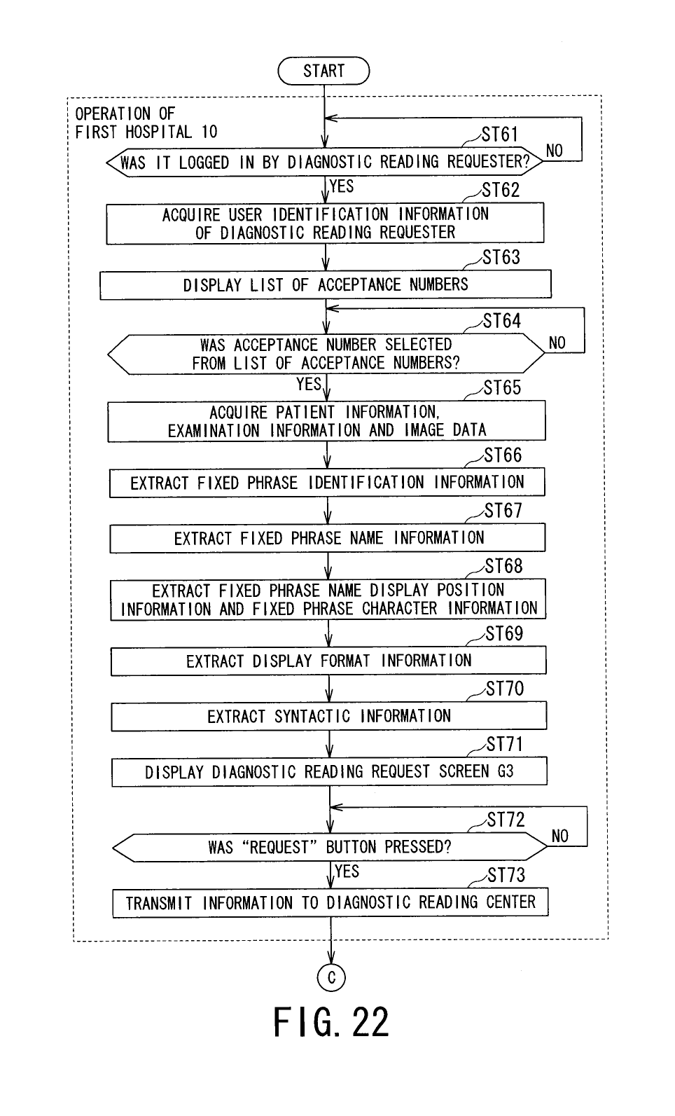

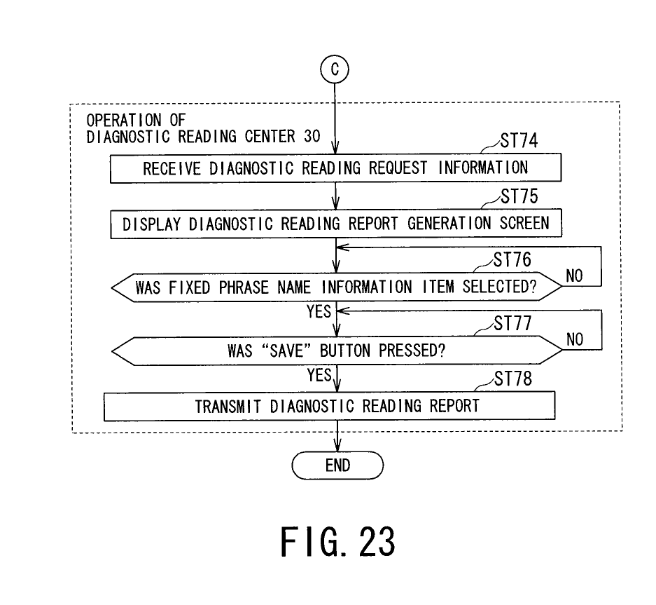

Next, an operation of the diagnostic reading report generation supporting system 1B according to the third embodiment is described with reference to a flow chart illustrated in FIG. 22 and FIG. 23.

First, the controller 41 of the diagnostic reading requesting apparatus 19 (or the diagnostic reading requesting apparatus 29) illustrated in FIG. 21 determines whether or not a diagnostic reading requester logs in to the diagnostic reading requesting apparatus 19 (Step ST61), and stands by for login by the diagnostic reading requester (NO in Step ST61). The diagnostic reading requester performs an input operation on the input device 43 of the diagnostic reading requesting apparatus 19 to input login information such as a user ID of the diagnostic reading requester and a login password, and thus logs in to the diagnostic reading requesting apparatus 19.

If the controller 41 determines that the diagnostic reading requester logs in (YES in Step ST61), the controller 41 of the diagnostic reading requesting apparatus 19 acquires user identification information such as the user ID of the diagnostic reading requester, from the inputted login information (Step ST62). Then, the controller 41 of the diagnostic reading requesting apparatus 19 causes the display device 44 to display a list of acceptance numbers indicating medical images as the diagnostic reading targets (Step ST63). The controller 41 of the diagnostic reading requesting apparatus 19 further determines whether or not an acceptance number is selected from the list of acceptance numbers (Step ST64), and stands by for selection of an acceptance number (NO in Step ST64). The diagnostic reading requester performs an input operation on the input device 43 of the diagnostic reading requesting apparatus 19 to select an acceptance number from the list of acceptance numbers.

If the controller 41 determines that an acceptance number is selected from the list of acceptance numbers (YES in Step ST64), the controller 41 of the diagnostic reading requesting apparatus 19 acquires patient information and examination information corresponding to the selected acceptance number from the diagnostic reading report server apparatus 13, and acquires image data corresponding to the selected acceptance number from the medical image server apparatus 12 (Step ST65).

Next, the controller 41 of the diagnostic reading requesting apparatus 19 extracts fixed phrase identification information corresponding to the user identification information acquired in Step ST62 and the examination information acquired in Step ST65, from the first table T1 (illustrated in FIG. 3) of the database 17-1 (Step ST66), and extracts fixed phrase name information also corresponding thereto, from the first table T1 (illustrated in FIG. 3) of the database 17-1 (Step ST67). For example, in FIG. 3, extracted are the fixed phrase identification information item “101” and the fixed phrase name information item “11 for CT” each corresponding to: the user identification information item “AB001”; and the examination type information item “CT” and the imaging region information item “head region” as the examination information. Similarly, extracted are the fixed phrase identification information item “102” and the fixed phrase name information item “12 for CT” each corresponding to: the user identification information item “AB001”; and the examination type information item “CT” and the imaging region information item “ALL” as the examination information. Similarly, extracted are the fixed phrase identification information item “106” and the fixed phrase name information item “common 11” each corresponding to: the user identification information item “ALL” including the user identification information item “AB001”; and the examination type information item “ALL” and the imaging region information item “ALL” as the examination information.

The controller 41 of the diagnostic reading requesting apparatus 19 extracts fixed phrase name display position information and fixed phrase character information each corresponding to the fixed phrase identification information extracted in Step ST66, from the second table T2 (illustrated in FIG. 4) of the database 17-2 (Step ST68). For example, in FIG. 4, extracted are the fixed phrase name display position information items “1, 2, 3, 4, or 5”, “1, 2, 3, 4, or 5”, “1, 2, 3, 4, or 5”, and “5” and the fixed phrase character information items “Compared with the last examination . . . ”, “re-examination required”, “At the subpleura of both the lung fields . . . ”, and “nothing abnormal detected” each corresponding to the fixed phrase identification information items “101”, “102”, “104”, and “106”.

Then, the controller 41 of the diagnostic reading requesting apparatus 19 extracts display format information corresponding to the user identification information acquired in Step ST62, from the third table T3 (illustrated in FIG. 5) of the database 17-3 (Step ST69). For example, in FIG. 5, extracted is the display format information item “101” corresponding to the user identification information item “AB001”.

Then, the controller 41 of the diagnostic reading requesting apparatus 19 extracts syntactic information corresponding to the display format information extracted in Step ST69, from the fourth table T4 (illustrated in FIG. 6) of the database 17-4 (Step ST70). For example, in FIG. 6, extracted is the syntactic information corresponding to the display format information item “101”.

Then, the controller 41 of the diagnostic reading requesting apparatus 19 causes the display device 44 of the diagnostic reading requesting apparatus 19 in the first hospital 10 to display, as a diagnostic reading request screen G3, the examination information and the image data acquired in Step ST65, the fixed phrase name information extracted in Step ST67, the fixed phrase name display position information and the fixed phrase character information extracted in Step ST68, and the syntactic information extracted in Step ST70 (Step ST71).

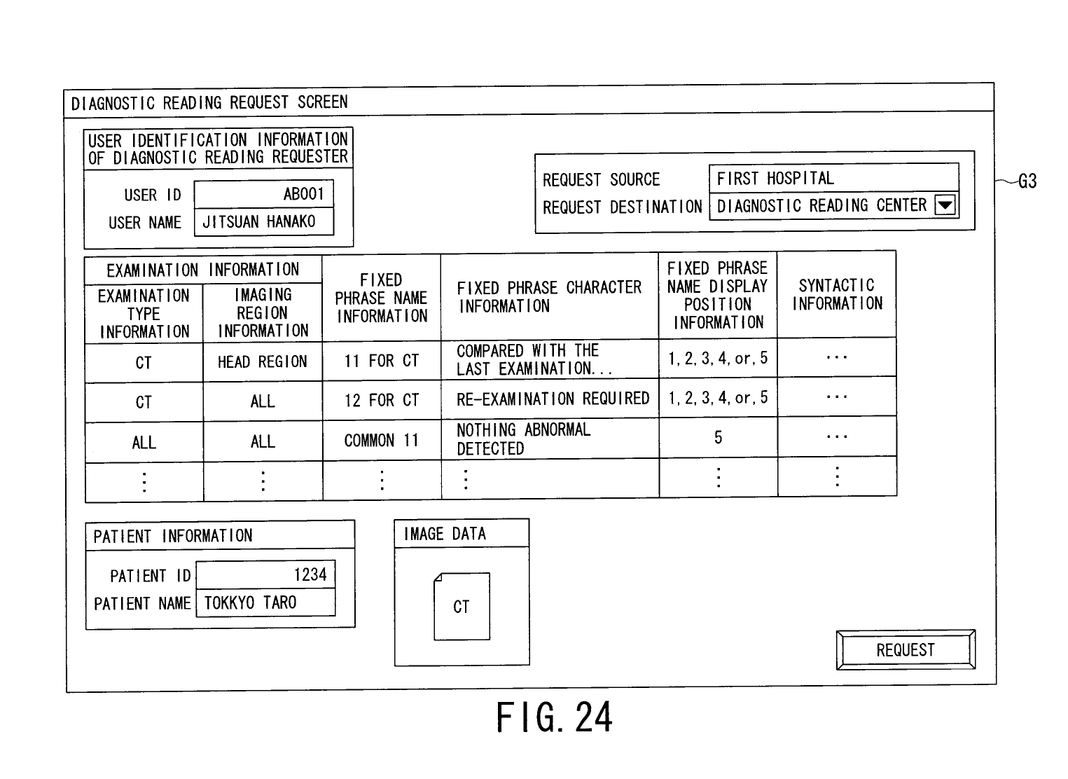

FIG. 24 is a diagram illustrating an example of the diagnostic reading request screen.

FIG. 24 illustrates the diagnostic reading request screen G3 concerning the patient ID “1234”, in which the user identification information item “AB001” of the diagnostic reading requester and the examination type information item “CT” and the imaging region information item “head region” as the examination information are set as the conditions. Specifically, the diagnostic reading request screen G3 includes: information on a diagnostic reading request source and a diagnostic reading request destination; patient information (for example, a patient ID and a patient name) of a diagnostic reading request target; and image data concerning the patient information of the diagnostic reading request target, which is extracted in Step ST65. The diagnostic reading request screen G3 includes the user identification information (for example, a user ID and a user name) of the diagnostic reading requester and the examination information (for example, examination type information and imaging region information), as the conditions. The diagnostic reading request screen G3 also includes: the fixed phrase name information extracted in Step ST67; the fixed phrase name display position information and the fixed phrase character information extracted in Step ST68; and the syntactic information extracted in Step ST70 on the basis of the conditions. The diagnostic reading requester selects a diagnostic reading request destination, and checks information to be transmitted, with the use of the input device 43 of the diagnostic reading requesting apparatus 19.

Returning back to the description of FIG. 22, the controller 41 of the diagnostic reading requesting apparatus 19 determines whether or not a “request” button is pressed (Step ST72), and stands by for press of the “request” button (NO in Step ST72). The “request” button is provided on, for example, the diagnostic reading request screen G3. In the case of transmitting, to the diagnostic reading center 30, the user identification information of the diagnostic reading requester, the examination information, the fixed phrase name information, the fixed phrase name display position information, the fixed phrase character information, the syntactic information, and the image data in association with one another, the diagnostic reading requester performs an input operation on the input device 43 of the diagnostic reading requesting apparatus 19 to click and press the “request” button. If the controller 41 determines that the “request” button is pressed (YES in Step ST72), diagnostic reading request information containing information in which the user identification information of the diagnostic reading requester, the examination information, the fixed phrase name information, the fixed phrase name display position information, the fixed phrase character information, the syntactic information, and the image data are associated with one another is exported and transmitted to the diagnostic reading center 30 via the router 18 and the network Nd (Step ST73).

Subsequently, the diagnostic reading center 30 receives the diagnostic reading request information that is transmitted by the first hospital 10 in Step ST73, via the network Nd and the router 38 (Step ST74).

Then, the controller 41 of the diagnostic reading report generation supporting apparatus 36 imports the diagnostic reading request information received in Step ST74, and causes the viewer apparatus for diagnostic reading 35 to display a diagnostic reading report generation screen based on the diagnostic reading request information (Step ST75). The diagnostic reading report generation screen displayed in Step ST75 is equivalent to that illustrated in FIG. 10.

The controller 41 of the diagnostic reading report generation supporting apparatus 36 determines whether or not a fixed phrase name information item is selected by the viewer apparatus for diagnostic reading 35 from the list P of the fixed phrase name information items (Step ST76), and stands by for selection of a fixed phrase name information item (NO in Step ST76). The report generator performs an input operation on an input device of the viewer apparatus for diagnostic reading 35 to attach a fixed phrase name information item included in the list P of the fixed phrase name information items to a predetermined location, and thus selects the fixed phrase name information item from the list P of the fixed phrase name information items. The method of selecting a fixed phrase name information item from the list P of the fixed phrase name information items is equivalent to that described with reference to FIG. 11A and FIG. 11B.

If the controller 41 determines that a fixed phrase name information item is selected from the list P of the fixed phrase name information items (YES in Step ST76), the controller 41 of the diagnostic reading report generation supporting apparatus 36 determines whether or not the “save” button is pressed by the viewer apparatus for diagnostic reading 35 (Step ST77), and stands by for press of the “save” button (NO in Step ST77). In the case of saving a diagnostic reading report after input, the report generator performs an input operation on the input device of the viewer apparatus for diagnostic reading 35 to click and press the “save” button. Note that, in the case where another button than the “save” button is pressed, processing corresponding to the another button is executed. If the controller 41 determines that the “save” button is pressed (YES in Step ST77), the controller 41 transmits the diagnostic reading report after input to the diagnostic reading report server apparatus 33 via the network Nc (Step ST78), and ends the processing. Through such processing as described above, the diagnostic reading report generation supporting operation is performed.

Note that, description is given above of the case where diagnostic reading request information is transmitted to the diagnostic reading center 30 at the timing of diagnostic reading request (transmission of diagnostic reading request information), but the present invention is not limited thereto. For example, diagnostic reading request information may be transmitted to the diagnostic reading center 30 at other timing than the timing of diagnostic reading request.

In Step ST73 illustrated in FIG. 22, diagnostic reading request information containing information in which the user identification information of the diagnostic reading requester, the examination information, the fixed phrase name information, the fixed phrase name display position information, the fixed phrase character information, the syntactic information, and the image data are associated with one another is transmitted to the diagnostic reading center 30, but the present invention is not limited thereto.

If the diagnostic reading requesting apparatus 19 receives a reservation of an examination (photographing) from a radiology information system (RIS), the diagnostic reading requesting apparatus 19 requests an X-ray film diagnosis apparatus as the medical imaging apparatus 11 to perform the examination. Upon the end of the examination by the X-ray film diagnosis apparatus, the diagnostic reading requesting apparatus 19 extracts fixed phrase identification information corresponding to the user identification information acquired in Step ST62 illustrated in FIG. 22 and the examination information of the requested examination, from the first table T1 (illustrated in FIG. 3) of the database 17-1 (Step ST66). After that, the operation is performed according to the flow chart illustrated in FIG. 22 and FIG. 23.

In this way, the diagnostic reading requesting apparatus 19 transmits, to the diagnostic reading center 30, diagnostic reading request information containing information in which the user identification information of the diagnostic reading requester, the examination information, the fixed phrase name information, the fixed phrase name display position information, the fixed phrase character information, and the syntactic information except the image data are associated with one another. Then, an X-ray film acquired by the X-ray film diagnosis apparatus is delivered to the diagnostic reading center 30 separately from the diagnostic reading request information.

According to the diagnostic reading report generation supporting system 1B of the third embodiment, the list P of appropriate fixed phrase name information items corresponding to the diagnostic reading requester and the examination is displayed, the fixed phrase name information items being generated by the diagnostic reading requester in the first hospital 10 (second hospital 20). Then, if the report generator selects a particular fixed phrase name information item from the list P of the fixed phrase name information items, the report generator can input fixed phrase character information corresponding to the particular fixed phrase name information item, into the medical comment input section Q. That is, according to the diagnostic reading report generation supporting system 1B of the third embodiment, only appropriate ones of a large number of fixed phrase name information items that are generated by the diagnostic reading requester in the first hospital 10 (second hospital 20) can be displayed as the list P. Hence, selection work of a fixed phrase name information item (fixed phrase character information item) is facilitated, and the generation efficiency of a diagnostic reading report by the report generator can be improved.

Further, according to the diagnostic reading report generation supporting system 1B of the third embodiment, not a list of fixed phrase character information items but the list P of the fixed phrase name information items is displayed. This eliminates the need for operations such as screen switching even if a large number of fixed phrase name information items are displayed, and hence the generation efficiency of a diagnostic reading report by the report generator can be improved.

Furthermore, according to the diagnostic reading report generation supporting system 1B of the third embodiment, even in the case where the diagnostic reading center 30 is requested to make a diagnostic reading, fixed phrase character information and the like used in the first hospital 10 and the second hospital 20 can be used also in the diagnostic reading center 30, and hence the generation efficiency of a diagnostic reading report by the report generator can be improved.

Note that the diagnostic reading report generation supporting systems 1, 1A, and 1B of the present embodiment are described for easy understanding of the present invention, and do not put a limit on the present invention. Accordingly, the elements disclosed in the diagnostic reading report generation supporting systems 1, 1A, and 1B of the present embodiment encompass all design changes and equivalents that belong to the technical range of the present invention.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A diagnostic reading report generation supporting system comprising:
a first storage configured to store a medical image;
a second storage configured to store: user identification information on a diagnostic reading requester; examination information on an examination for collecting the medical image; fixed phrase name information that is character information for identifying a fixed phrase; and fixed phrase character information that is character information of the fixed phrase;
a first extraction unit configured to extract a medical image as a diagnostic reading target, from the first storage;
a second extraction unit configured to extract a fixed phrase name information item corresponding to a required user identification information item and examination information item, from the second storage; and
a transmission unit configured to transmit diagnostic reading request information including: the extracted medical image; the extracted fixed phrase name information item; and a user identification information item, an examination information item and a fixed phrase character information item associated with the extracted fixed phrase name information item, to an external apparatus via a network.

2. The diagnostic reading report generation supporting system according to claim 1,
wherein the examination information stored in the second storage at least includes: examination type information indicating a type of a medical imaging apparatus; and imaging region information.

3. The diagnostic reading report generation supporting system according to claim 1, further comprising:
a list display controller configured to display a list of the extracted fixed phrase name information items; and
a character display controller configured to cause, if a particular fixed phrase name information item is selected from the displayed list of the fixed phrase name information items, a display device to display a particular fixed phrase character information item corresponding to the selected particular fixed phrase name information item.

4. The diagnostic reading report generation supporting system according to claim 3, further comprising:
a third storage configured to store the user identification information and the examination information in association with fixed phrase name display position information indicating a display position of the fixed phrase name information; and
a third extraction unit configured to extract a display position information item corresponding to the user identification information item and the examination information item, from the third storage,
wherein the list display controller is configured to display the list of the extracted fixed phrase name information items at an arrangement according to the extracted display position information item on a basis of the extracted fixed phrase name information items.

5. The diagnostic reading report generation supporting system according to claim 3, further comprising:
a fourth storage configured to store the user identification information in association with display format information for displaying the fixed phrase name information; and
a fourth extraction unit configured to extract a display format information item corresponding to the user identification information item, from the fourth storage,
wherein the list display controller is configured to display the list of the extracted fixed phrase name information items in a format suited to the extracted display format information item on a basis of the extracted fixed phrase name information items.

6. The diagnostic reading report generation supporting system according to claim 3, further comprising,
a selection unit configured to select, if a fixed phrase name information item included in the displayed list of the fixed phrase name information items is moved to a predetermined region on a display, the fixed phrase name information item as the particular fixed phrase name information item.

7. The diagnostic reading report generation supporting system according to claim 3, further comprising:
a first apparatus; and
a second apparatus connected to the first apparatus via a network;
wherein the first apparatus includes the first extraction unit, the second extraction unit, and the list display controller,
the second apparatus includes:
a reception unit configured to receive, via the network, user identification information, examination information, fixed phrase name information, and fixed phrase character information transmitted from the first apparatus, in association with one another;
a fifth storage configured to store the received user identification information, examination information, fixed phrase name information, and fixed phrase character information in association with one another;
a reception-side extraction unit configured to extract a fixed phrase name information item corresponding to a user identification information item and an examination information item, from the fifth storage;
a reception-side list display controller configured to display a list of the extracted fixed phrase name information items; and
a reception-side character display controller configured to cause, if a particular fixed phrase name information item is selected from the displayed list of the fixed phrase name information items, a display apparatus to display a particular fixed phrase character information item corresponding to the selected particular fixed phrase name information item.

8. A diagnostic reading report generation supporting apparatus comprising:
a first storage configured to store a medical image;
a second storage configured to store: user identification information on a diagnostic reading requester; examination information on an examination for collecting the medical image; fixed phrase name information that is character information for identifying a fixed phrase; and fixed phrase character information that is character information of the fixed phrase;
a first extraction unit configured to extract a medical image as a diagnostic reading target, from the first storage;
a second extraction unit configured to extract a fixed phrase name information item corresponding to a required user identification information item and examination information item, from the second storage; and
a transmission unit configured to transmit diagnostic reading request information including: the extracted medical image; the extracted fixed phrase name information item; and a user identification information item, an examination information item and a fixed phrase character information item associated with the extracted fixed phrase name information item, to an external apparatus via a network.

9. A diagnostic reading report generation supporting system comprising:
a storage configured to store: user identification information on a diagnostic reading requester; examination information on an examination for collecting the medical image; fixed phrase name information that is character information for identifying a fixed phrase; and fixed phrase character information that is character information of the fixed phrase;
an extraction unit configured to extract a fixed phrase name information item corresponding to a required user identification information item and examination information item, from the storage; and
a transmission unit configured to transmit diagnostic reading request information including: the extracted fixed phrase name information item; and a user identification information item, an examination information item and a fixed phrase character information item associated with the extracted fixed phrase name information item, to an external apparatus via a network.

10. A diagnostic reading requesting apparatus comprising:
an extraction unit configured to extract a fixed phrase name information item corresponding to a required user identification information item and examination information item, from an extraction unit configured to extract a fixed phrase name information item corresponding to a required user identification information item and examination information item, from a storage which store: user identification information on a diagnostic reading requester; examination information on an examination for collecting the medical image; fixed phrase name information that is character information for identifying a fixed phrase; and fixed phrase character information that is character information of the fixed phrase; and
a transmission unit configured to transmit diagnostic reading request information including: the extracted fixed phrase name information item; and a user identification information item, an examination information item and a fixed phrase character information item associated with the extracted fixed phrase name information item, to an external apparatus via a network.
